(19) United States
(12) Patent Application Publication
(10) Pub. No.: US 2025/0330654 A1
(43) Pub. Date: Oct. 23, 2025

(54) ENCODING METHOD AND APPARATUS, DECODING METHOD AND APPARATUS, ENCODING DEVICE, DECODING DEVICE, AND STORAGE MEDIUM

(71) Applicant: GUANGDONG OPPO MOBILE TELECOMMUNICATIONS CORP., LTD., Dongguan (CN)

(72) Inventor: Zhihuang XIE, Dongguan (CN)

(21) Appl. No.: 19/256,603

(22) Filed: Jul. 1, 2025

Related U.S. Application Data
(63) Continuation of application No. PCT/CN2023/070112, filed on Jan. 3, 2023.

(51) Int. Cl. H04N 19/82; H04N 19/117; H04N 19/159; H04N 19/174; H04N 19/189; H04N 19/96

(52) U.S. Cl. CPC H04N 19/82; H04N 19/117; H04N 19/159; H04N 19/174; H04N 19/189; H04N 19/96

(57) ABSTRACT

A decoding method includes: decoding a bitstream to determine a relevant syntax element of a current coding tree unit; determining, based on the relevant syntax element, a target in-loop filter model of the current coding tree unit from candidate in-loop filter models based on neural network; determining reference sample information of the current coding tree unit; and inputting the reference sample information of the current coding tree unit into the target in-loop filter model for filtering, to output filtered reconstructed sample information.

### CROSS-REFERENCE TO RELATED APPLICATION

This application is a Continuation Application of International Application No. PCT/CN2023/070112 filed on Jan. 3, 2023, which is incorporated herein by reference in its entirety.

### TECHNICAL FIELD

Embodiments of the present disclosure relate to the field of video encoding and video decoding technology, and particularly, to an encoding method, a decoding method, an encoding apparatus, a decoding apparatus, an encoding device, a decoding device, and a storage medium.

### BACKGROUND

As people's requirements for video display quality increase, new video applications such as high-definition and ultra-high-definition video have emerged. The Joint Video Exploration Team (JVET) of the International Organization for Standardization (ISO)/International Electro-technical Commission (IEC) and International Telecommunication Union-Telecommunication Standardization Sector (ITU-T) has developed the next-generation video coding standard H.266/Versatile Video Coding (VVC).

Currently, neural networks have been introduced into the field of video encoding and decoding. With the powerful learning capability of neural networks, neural network-based encoding and decoding tools often exhibit highly efficient encoding and decoding performance. For example, there are a neural network-based intra-prediction method, a neural network-based inter-prediction method, and a neural network-based in-loop filter method. Among them, the coding performance of the neural network-based in-loop filter method is the most outstanding. However, the current neural network-based in-loop filter method has not fully utilized the advantages of a neural network model. In some encoding and decoding scenarios, the neural network-based in-loop filter method has little improvement on the filtering effect and may even reduce the filtering efficiency. Therefore, the neural network-based in-loop filter method needs to be optimized.

### SUMMARY

Embodiments of the present disclosure provide an encoding method, a decoding method, an encoding apparatus, a decoding apparatus, an encoding device, a decoding device, and a storage medium.

In a first aspect, an embodiment of the present disclosure provides a decoding method, including:
decoding a bitstream to determine a relevant syntax element of a current coding tree unit;
determining, based on the relevant syntax element, a target in-loop filter model of the current coding tree unit from candidate in-loop filter models based on neural network;
determining reference sample information of the current coding tree unit; where the reference sample information at least includes: predicted sample information of the current coding tree unit and/or reconstructed sample information of the current coding tree unit; and
inputting the reference sample information of the current coding tree unit into the target in-loop filter model for filtering, to output filtered reconstructed sample information.

In a second aspect, an embodiment of the present disclosure provides an encoding method, including:
determining reference sample information of a current coding tree unit; where the reference sample information at least includes: predicted sample information of the current coding tree unit and/or reconstructed sample information of the current coding tree unit;
inputting the reference sample information of the current coding tree unit into each of candidate in-loop filter models based on neural network for filtering, to output respective filtered reconstructed sample information;
determining, based on original sample information of the current coding tree unit and the respective filtered reconstructed sample information, a respective first distortion cost value of the current coding tree unit;
determining, based on first distortion cost values of the current coding tree unit, a target in-loop filter model of the current coding tree unit from the candidate in-loop filter models based on neural network; and
encoding a relevant syntax element of the target in-loop filter model of the current coding tree unit, and signaling obtained encoded bits into a bitstream.

In a third aspect, an embodiment of the present disclosure provides a decoding apparatus, including:
a decoding unit, configured to decode a bitstream to determine a relevant syntax element of a current coding tree unit;
a first determining unit, configured to determine, based on the relevant syntax element, a target in-loop filter model of the current coding tree unit from candidate in-loop filter models based on neural network;
a second determining unit, configured to determine reference sample information of the current coding tree unit; where the reference sample information at least includes: predicted sample information of the current coding tree unit and/or reconstructed sample information of the current coding tree unit; and
a filtering unit, configured to input the reference sample information of the current coding tree unit into the target in-loop filter model for filtering, to output filtered reconstructed sample information.

In a fourth aspect, an embodiment of the present disclosure provides an encoding apparatus, including:
a first determining unit, configured to determine reference sample information of a current coding tree unit; where the reference sample information at least includes: predicted sample information of the current coding tree unit and/or reconstructed sample information of the current coding tree unit;
a filtering unit, configured to input the reference sample information of the current coding tree unit into each of candidate in-loop filter models based on neural network for filtering, to output respective filtered reconstructed sample information;
a second determining unit, configured to determine, based on original sample information of the current coding tree unit and the respective filtered reconstructed sample information, a respective first distortion cost value of the current coding tree unit; and determine, based on first distortion cost values of the current coding tree unit, a target in-loop filter model of the current coding tree unit from the candidate in-loop filter models based on neural network; and
a coding unit, configured to encode a relevant syntax element of the target in-loop filter model of the current coding tree unit, and signal obtained encoded bits into a bitstream.

In a fifth aspect, an embodiment of the present disclosure further provides a decoding device, including: a first memory and a first processor, where the first memory stores a computer program executable on the first processor, and the first processor executes the computer program to implement the decoding method of a decoder.

In a sixth aspect, an embodiment of the present disclosure further provides an encoding device, including: a second memory and a second processor, where the second memory stores a computer program executable on the second processor, and the second processor executes the computer program to implement the encoding method of an encoder.

In a seventh aspect, an embodiment of the present disclosure provides a non-transitory computer-readable storage medium, having stored thereon a computer program that when being executed by a first processor, implements the decoding method of a decoder; or when being executed by a second processor, implements the encoding method of an encoder.

In an eighth aspect, an embodiment of the present disclosure provides a non-transitory computer-readable storage medium, having stored thereon a bitstream. The bitstream is generated according to the encoding method described in the second aspect.

### BRIEF DESCRIPTION OF THE DRAWINGS

FIG. 1 is a schematic block diagram of an encoder provided in the embodiments of the present disclosure.

FIG. 2 is a schematic block diagram of a decoder provided in the embodiments of the present disclosure.

FIG. 3 is a flowchart of a decoding method provided in the embodiments of the present disclosure.

FIG. 4 is a schematic diagram of a first neural network model provided in the embodiments of the present disclosure.

FIG. 5 is a schematic diagram of an attention residual block provided in the embodiments of the present disclosure.

FIG. 6 is a schematic diagram of a second neural network model provided in the embodiments of the present disclosure.

FIG. 7 is a schematic diagram of a residual block provided in the embodiments of the present disclosure.

FIG. 8 is a schematic diagram of a third neural network model provided in the embodiments of the present disclosure.

FIG. 9 is a flowchart of an encoding method provided in the embodiments of the present disclosure.

FIG. 10 is a schematic diagram of the structure of a decoding apparatus provided in the embodiments of the present disclosure.

FIG. 11 is a schematic diagram of a specific hardware structure of a decoding device provided in the embodiments of the present disclosure.

FIG. 12 is a schematic diagram of a composition structure of an encoding apparatus provided in the embodiments of the present disclosure.

FIG. 13 is a schematic diagram of a specific hardware structure of an encoding device provided in the embodiments of the present disclosure.

FIG. 14 is a schematic diagram of a composition structure of an encoding and decoding system provided in the embodiments of the present disclosure.

### DETAILED DESCRIPTION

In order to more thoroughly understand the features and technical contents of the embodiments of the present disclosure, the implementation of the present disclosure will be further described in detail below with reference to the accompanying drawings. The attached drawings are for reference only and are not intended to limit the embodiments of the present disclosure.

Unless defined otherwise, all technical and scientific terms used herein have the same meaning as commonly understood by those ordinary skilled in the art. The terms used herein are only for the purpose of describing the embodiments of the present disclosure and are not intended to limit the present disclosure.

In the following description, reference is made to “some embodiments”, which describe a subset of all possible embodiments, but it will be understood that “some embodiments” may be the same subset or different subsets of all possible embodiments and may be combined with each other without conflict. It should also be pointed out that the terms “first \second\third” involved in the embodiments of the present disclosure are only used to distinguish similar objects and do not represent a specific ordering of the objects. It can be understood that “first\second\third” can be interchanged in a specific order or sequence where permitted, so that the embodiments of the present disclosure described here may be implemented in an order other than that illustrated or described here.

The embodiments of the present disclosure will be described in detail below with reference to the accompanying drawings.

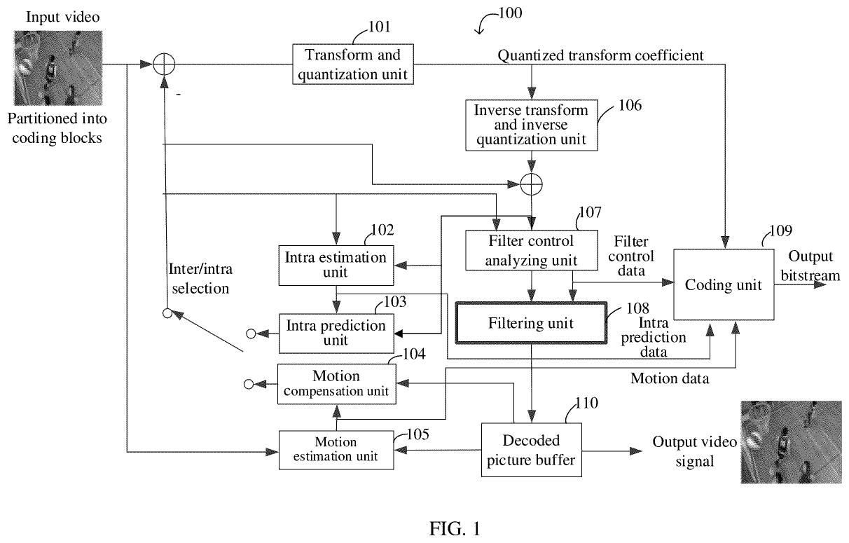

FIG. 1 is a schematic block diagram of an encoder provided in the embodiments of the present disclosure. As illustrated in FIG. 1, the encoder (specifically, a “video encoder”) 100 may include a transform and quantization unit 101, an intra estimation unit 102, an intra prediction unit 103, a motion compensation unit 104, a motion estimation unit 105, an inverse transform and inverse quantization unit 106, a filter control and analysis unit 107, a filtering unit 108, a coding unit 109, and a decoded picture buffer unit 110, etc., where the filtering unit 108 may realize deblocking filtering and sample adaptive offset (SAO) filtering, and the coding unit 109 may realize header information coding and context-based adaptive binary arithmetic coding (CABAC). For the input original video signal, a video coding block can be obtained by dividing a coding tree unit (CTU), and then the residual pixel information of the video encoding block obtained after performing intra prediction or inter prediction is transformed by the transform and quantization unit 101, including transforming the residual information from a pixel domain to a transform domain and quantizing the resulting transform coefficients, in order to further reduce a bit rate; the intra estimation unit 102 and the intra prediction unit 103 are used for performing intra prediction of the video coding block. Explicitly speaking, the intra estimation unit 102 and the intra prediction unit 103 are used for determining an intra prediction mode to be used for encoding the video coding block. The motion compensation unit 104 and the motion estimation unit 105 are used for performing inter prediction coding on the received video coding block with respect to one or more blocks in one or more reference pictures to provide temporal prediction information. The motion estimation performed by the motion estimation unit 105 is a process of generating motion vectors, where the motion vectors estimating the motion of the video coding block, and then the motion compensation unit 104 performs motion compensation based on the motion vectors determined by the motion estimation unit 105. After determining the intra prediction mode, the intra prediction unit 103 is also used to provide the selected intra prediction data to the coding unit 109, and the motion estimation unit 105 sends the motion vector data determined by calculation to the coding unit 109 as well. Furthermore, the inverse transform and inverse quantization unit 106 is used for reconstruction of the video coding block, reconstructing the residual block in the pixel domain, the reconstructed residual block removes blocking effect artifacts by the filter control analysis unit 107 and the filtering unit 108, and then adding the reconstructed residual block to a prediction block in the frame/picture of the decoded picture buffer unit 110 for generating the reconstructed video coding block. The coding unit 109 is used for coding the various coding parameters and quantized transform coefficients. In CABAC-based coding algorithms, the contextual content may be based on neighboring coding blocks, and may be used to encode information indicative of the determined intra prediction mode to output a bitstream of the video signal; and the decoded picture buffer unit 110 is used for storing the reconstructed video coding block for prediction reference. As the video picture encoding proceeds, new reconstructed video coding blocks are continuously generated, and these reconstructed video coding blocks are stored in the decoded picture buffer unit 110.

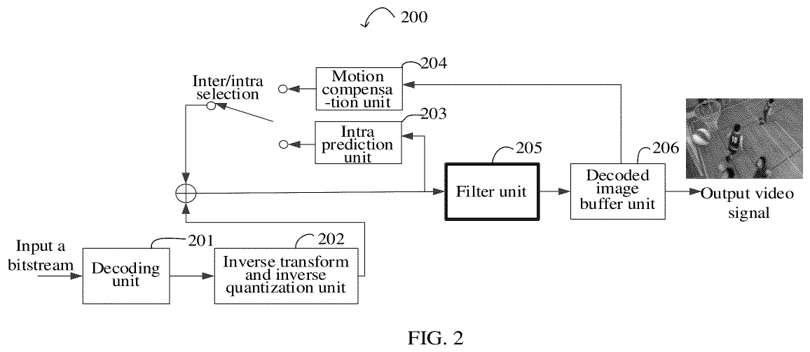

FIG. 2 is a schematic block diagram of a decoder provided in the embodiments of the present disclosure. As illustrated in FIG. 2, the decoder (specifically, a “video decoder”) 200 includes a decoding unit 201, an inverse transform and inverse quantization unit 202, an intra prediction unit 203, a motion compensation unit 204, a filtering unit 205, and a decoded picture buffer unit 206, etc., where the decoding unit 201 may implement header information decoding and CABAC decoding, and the filtering unit 205 may implement deblocking filtering and SAO filtering. After an input video signal is encoded in FIG. 1, a bitstream of the video signal is output; the bitstream is input into the decoder 200, and is processed by the decoding unit 201 first to obtain decoded transform coefficients. The transform coefficients are processed by the inverse transform and inverse quantization unit 202 in order to generate a residual block in a pixel domain; and the intra prediction unit 203 may be used to generate prediction data for a current video decoding block based on the determined intra prediction mode and data from a previously decoded block of the current frame or picture; the motion compensation unit 204 is used to determine prediction information for the video decoding block by analyzing the motion vectors and other associated syntactic elements and to use the prediction information to generate prediction blocks for the video decoding block that is being decoded; and the video decoding block is formed by summing the residual block from the inverse transform and inverse quantization unit 202 with a corresponding prediction block generated by the intra prediction unit 203 or the motion compensation unit 204; the decoded video signal is processed by the filtering unit 205 in order to remove the blocking effect artifacts, which may improve the quality of the video; and then the decoded video block is stored in the decoded picture buffer unit 206, the decoded picture buffer unit 206 stores a reference picture for subsequent intra prediction or motion compensation, and also for the output of the video signal, that is, the recovered original video signal is obtained.

It should be noted that the method of the embodiments of the present disclosure is mainly applied to the sections of filtering unit 108 illustrated in FIG. 1 and the filtering unit 205 illustrated in FIG. 2. That is, the embodiments of the present disclosure may be applied to an encoder or a decoder, or even to both an encoder and a decoder, but the embodiments of the present disclosure are not specifically limited.

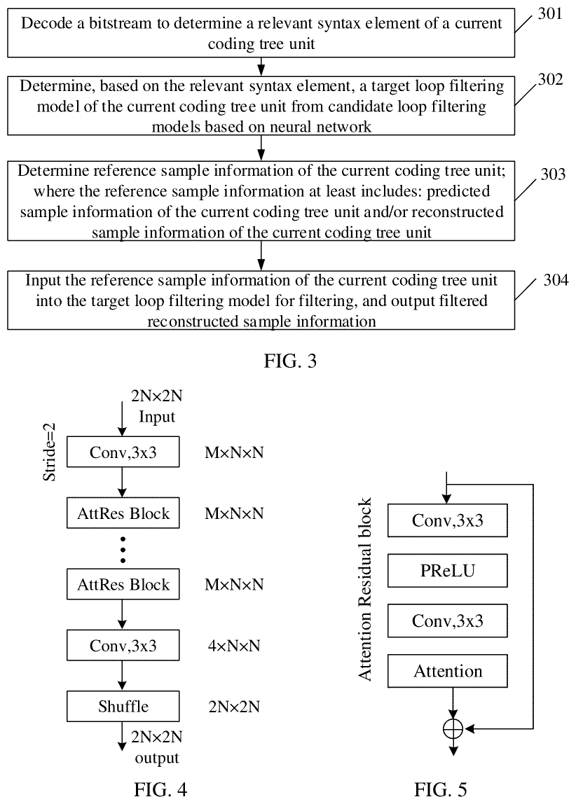

In an embodiment of the present disclosure, FIG. 3 is a flowchart of a decoding method provided in the embodiments of the present disclosure. As illustrated in FIG. 3, the method may include a step 301, a step 302, a step 303 and a step 304.

In the step 301, a bitstream is decoded to determine a relevant syntax element of a current coding tree unit.

In the step 302, a target in-loop filter model of the current coding tree unit is determined based on the relevant syntax element from candidate in-loop filter models based on neural network.

The relevant syntax element is used to indicate the target in-loop filter model of the coding tree unit, the relevant syntax element includes one or more of a sequence level syntax element, a picture level syntax element, a slice level syntax element, and a coding tree unit level syntax element.

Exemplarily, in some embodiments, the relevant syntax element includes a first syntax element. The target in-loop filter model of the current coding tree unit is determined based on the first syntax element from candidate in-loop filter models based on neural network (which may also be referred to as “neural network-based candidate in-loop filter models).

In some embodiments, the first syntax element includes one of: a first syntax element at a picture sequence level, used for indicating target in-loop filter models of all coding tree units in a picture sequence; a first syntax element at a picture level, used for indicating target in-loop filter models of all coding tree units in a picture; a first syntax element at a slice level, used for indicating target in-loop filter models of all coding tree units in a slice; and a first syntax element at a coding tree unit level, used for indicating a target in-loop filter model of a coding tree unit.

Exemplarily, in some embodiments, the relevant syntax element further includes a second syntax element. The method further includes: determining, based on a second syntax element, whether a second in-loop filter model based on neural network is allowed to be enabled for a current picture block in which the current coding tree unit is located, where the second in-loop filter model is a candidate in-loop filter model; and determining, based on the first syntax element, the target in-loop filter model of the current coding tree unit, from the candidate in-loop filter models based on neural network, in a case where it is determined, based on the second syntax element, that the second in-loop filter model based on neural network is enabled for the current picture block in which the current coding tree unit is located. It is determined, based on the second syntax element, that the second in-loop filter model is allowed to be enabled (used), and it is further determined, based on the first syntax element, the target in-loop filter model. It is determined, based on the second syntax element, that the second in-loop filter model is not allowed to be enabled (used), and it is further determined that a preset first in-loop filter model is enabled (used), or it is determined that a neural network-based in-loop filter technology is not enabled (used), or it is determined that another filtering technology is enabled (used). The first in-loop filter model is a candidate in-loop filter model, or the first in-loop filter model is not the candidate in-loop filter model.

Exemplarily, the current picture block includes at least one of: a picture sequence in which the current coding tree unit is located, a picture in which the current coding tree unit is located, a slice in which the current coding tree unit is located, or a current picture tree unit.

Exemplarily, the candidate in-loop filter model includes a first in-loop filter model and a second in-loop filter model, the first in-loop filter model being understood as an original in-loop filter model, and the second in-loop filter model being understood as a replaced in-loop filter model for the original in-loop filter model. Determining that the second in-loop filter model is allowed to be enabled indicates that any one of in-loop filter models may be selected from the candidate in-loop filter models, and determining that the second in-loop filter model is not allowed to be enabled indicates that only the first in-loop filter model may be enabled.

Exemplarily, the second syntax element includes at least one of: a second syntax element at a picture sequence level, used for indicating whether the second in-loop filter model based on neural network is allowed to be enabled for a picture sequence; a second syntax element at a picture level, used for indicating whether the second in-loop filter model based on neural network is allowed to be enabled for a picture; a second syntax element at a slice level, used for indicating whether the second in-loop filter model based on neural network is allowed to be enabled for a slice; or a second syntax element at a coding tree unit level, used for indicating whether the second in-loop filter model based on neural network is allowed to be enabled for a coding tree unit.

In some embodiments, the second syntax element includes a second syntax element at a picture sequence level. In some embodiments, the second syntax element includes a second syntax element at a picture sequence level and a second syntax element at a picture level. In some embodiments, the second syntax element includes a second syntax element at a picture sequence level and a second syntax element at a slice level. In some embodiments, the second syntax element includes a second syntax element at a picture sequence level, a second syntax element at a picture level (or slice level), and a second syntax element at a coding tree unit level.

Exemplarily, in some embodiments, the relevant syntax element further includes a third syntax element. It is determined, based on the third syntax element, whether a neural network-based in-loop filter technology is enabled for a current picture block in which the current coding tree unit is located. In a case where it is determined, based on the third syntax element, that the neural network-based in-loop filter technology is enabled for the current picture block in which the current coding tree unit is located, a target in-loop filter model of the current coding tree unit is determined based on the first syntax element from the candidate in-loop filter models based on neural network. In some embodiments, in a case where the third syntax element is a first preset value, it is determined that the neural network-based in-loop filter technology is not enabled for all coding tree units in the current picture block; in a case where the third syntax element is a second preset value, it is determined that the neural network-based in-loop filter technology is enabled for all coding tree units in the current picture block; and in a case where the third syntax element is a third preset value, it is determined that the neural network-based in-loop filter technology is enabled for some coding tree units in the current picture block.

Exemplarily, in some embodiments, the third syntax element includes at least one of: a third syntax element at a picture sequence level, used for indicating whether the neural network-based in-loop filter technology is enabled for a picture sequence; a third syntax element at a picture level, used for indicating whether the neural network-based in-loop filter technology is enabled for a picture; a third syntax element at a slice level, used for indicating whether the neural network-based in-loop filter technology is enabled for a slice; or a third syntax element at a coding tree unit level, used for indicating whether the neural network-based in-loop filter technology is enabled for a coding tree unit.

In some embodiments, the third syntax element includes a third syntax element at a picture sequence level. In some embodiments, the third syntax element includes a third syntax element at a picture sequence level and a third syntax element at a picture level. In some embodiments, the third syntax element includes a third syntax element at a picture sequence level and a third syntax element at a slice level. In some embodiments, the third syntax element includes a third syntax element at a picture sequence level, a third syntax element at a picture level (or a slice level), and a third syntax element at a coding tree unit level.

Exemplarily, in some embodiments, the relevant syntax element further includes a fourth syntax element. Based on the fourth syntax element, a picture type of the current coding tree unit or a slice type of the current coding tree unit is determined. In a case where it is determined, based on the fourth syntax element, that the picture type of the current coding tree unit or the slice type of the current coding tree unit is a preset type, a target in-loop filter model of the current coding tree unit is determined based on the first syntax element from the candidate in-loop filter models based on neural network. That is, in a case where the picture type or the slice type of the current coding tree unit is a preset type, the candidate in-loop filter model based on neural network is allowed to be enabled for in-loop filter, otherwise, the candidate in-loop filter model based on neural network is not allowed to be enabled for in-loop filter. For different picture types or slice types, such as intra I_Slice and dual reference picture B_Slice, different models can be used, and then the input part may be different. Specifically, for example, the I_Slice model may have one more partition information as an input. For different color components, there may be different applicable models, in this case, the input information may also be different. Specifically, for example, the model of chroma component generally not only need to input reconstructed sample information rec of a chroma component for example, but also need to input reconstructed sample information rec of a luma component, so as to improve the filtering performance.

In some embodiments, the picture type or the slice type is B_slice, and a target in-loop filter model of the current coding tree unit is determined based on the first syntax element from the candidate in-loop filter models based on neural network.

In some embodiments, the fourth syntax element includes one of: a fourth syntax element at a picture sequence level, used for indicating a picture type or a slice type of all coding tree units in a picture sequence; a fourth syntax element at a picture level, used for indicating a picture type or a slice type of all coding tree units in a picture; a fourth syntax element at a slice level, used for indicating a picture type or a slice type of all coding tree units in a slice; and a fourth syntax element at a coding tree unit level, used for indicating a picture type or a slice type of a coding tree unit.

In some embodiments, the relevant syntax element further includes a fifth syntax element. It is determined, based on the fifth syntax element, whether a neural network-based in-loop filter technology is allowed to be enabled (used) for the current picture block. In a case where it is determined, based on the fifth syntax element, that the neural network-based in-loop filter technology is allowed to be enabled (used), a target in-loop filter model is determined by parsing a subsequent relevant syntax element; and in a case where it is determined, based on the fifth syntax element, that the neural network-based in-loop filter technology is not allowed to be enabled (used), another filtering technology is enabled (used), or no filtering technology is enabled (used).

In some embodiments, the fifth syntax element includes at least one of: a fifth syntax element at a picture sequence level, used for indicating whether the neural network-based in-loop filter technology is enabled for a picture sequence; a fifth syntax element at a picture level, used for indicating whether the neural network-based in-loop filter technology is enabled for a picture; a fifth syntax element at a slice level, used for indicating whether the neural network-based in-loop filter technology is enabled for a slice; or a fifth syntax element at a coding tree unit level, used for indicating whether the neural network-based in-loop filter technology is enabled for a coding tree unit.

In some embodiments, the fifth syntax element includes a fifth syntax element at a picture sequence level. In some embodiments, the fifth syntax element includes a fifth syntax element at a picture sequence level and a fifth syntax element at a picture level. In some embodiments, the fifth syntax element includes a fifth syntax element at a picture sequence level and a fifth syntax element at a slice level. In some embodiments, the fifth syntax element includes a fifth syntax element at a picture sequence level, a fifth syntax element at a picture level (or a slice level), and a fifth syntax element at a coding tree unit level.

In summary, in a case where it is determined, based on at least one of the second syntax element, the third syntax element, the fourth syntax element, or the fifth syntax element, that a candidate in-loop filter model based on neural network is enabled for the current picture block, a target in-loop filter model is determined based on the first syntax element from the candidate in-loop filter models.

In the step 303, reference sample information of the current coding tree unit is determined. The reference sample information at least includes: predicted sample information of the current coding tree unit and/or reconstructed sample information of the current coding tree unit.

Exemplarily, as illustrated in FIG. 1, each picture in an input video is divided into square largest coding units (LCUs) of the same size (e.g., 128×128, 64×64, etc.). Each largest coding unit may be divided into rectangular coding units (CUs) according to a rule. The coding unit may also be divided into prediction units (PUs), transform units (TUs), and so on. A hybrid coding framework includes prediction, transform, quantization, entropy coding, in in-loop filter and other modules. The prediction module includes intra prediction and inter prediction. The inter prediction includes motion estimation and motion compensation. Since there is a strong correlation between neighboring pixels in a picture of the video, the intra prediction is used in video encoding and decoding techniques to eliminate spatial redundancy between neighboring pixels. Due to the strong similarity between neighboring pictures in the video, an inter prediction method is used in video encoding and decoding techniques to eliminate temporal redundancy between neighboring pictures (or frames), thus improving the encoding and decoding efficiency.

The intra prediction or inter prediction is used for a current block to generate a prediction block of the current block, and the prediction block of the coding tree unit (i.e., predicted sample information) is composed according to the prediction block of the current block. On the other hand, a bitstream is parsed to get a quantization coefficient matrix, inverse quantization and inverse transform are performed on the quantization coefficient matrix to get a residual block, and the prediction block and the residual block are summed to get a reconstructed block. Reconstructed blocks form a reconstructed picture (i.e., reconstructed sample information) of the coding tree unit, and in-loop filter is performed on the reconstructed picture to obtain a decoded picture by taking the coding tree unit (i.e., the largest coding unit size.) as a basic processing unit.

In some embodiments, the reconstructed sample information includes reconstructed sample information of the first color component of the current coding tree unit and reconstructed sample information of the second color component of the current coding tree unit, and the predicted sample information includes predicted sample information of the first color component of the current coding tree unit and predicted sample information of the second color component of the current coding tree unit. Specifically, for example, in a case where in-loop filter is performed on a chroma component, for example, not only the reconstructed sample information rec of the chroma component, but also the reconstructed sample information rec of the luma component are generally required to be input into the in-loop filter model of the chroma component, so as to improve the filtering performance.

Exemplarily, in some embodiments, the current picture block includes at least one of: a picture sequence in which the current coding tree unit is located, a picture in which the current coding tree unit is located, a slice in which the current coding tree unit is located, or a current picture tree unit.

In the step 304, the reference sample information of the current coding tree unit is input into the target in-loop filter model for filtering, to output the filtered reconstructed sample information.

In some embodiments, the reference sample information further includes: a quantization parameter; and the method further includes:
determining, based on a sixth syntax element, whether to adjust a quantization parameter of a current picture block in which the current coding tree unit is located; determining, based on a seventh syntax element, an adjusted quantization parameter of the current picture block in which the current coding tree unit is located, in a case where it is determined, based on the sixth syntax element, to adjust the quantization parameter of the current picture block in which the current coding tree unit is located; and inputting the adjusted quantization parameter into the target in-loop filter model.

In some embodiments, the sixth syntax element includes at least one of: a sixth syntax element at a picture sequence level, used for indicating whether to adjust a quantization parameter of a coding tree unit in a picture sequence; a sixth syntax element at a picture level, used for indicating whether to adjust a quantization parameter of a coding tree unit in a picture; a sixth syntax element at a slice level, used for indicating whether to adjust a quantization parameter of a coding tree unit in a slice; or a sixth syntax element at a coding tree unit level, used for indicating whether to adjust a quantization parameter of a coding tree unit.

In some embodiments, the sixth syntax element includes a sixth syntax element at a picture sequence level. In some embodiments, the sixth syntax element includes a sixth syntax element at a picture sequence level and a sixth syntax element at a picture level. In some embodiments, the sixth syntax element includes a sixth syntax element at a picture sequence level and a sixth syntax element at a slice level. In some embodiments, the sixth syntax element includes a sixth syntax element at a picture sequence level, a sixth syntax element at a picture level (or a slice level), and a sixth syntax element at a coding tree unit level.

The seventh syntax element includes one of: a seventh syntax element at a picture sequence level, used for indicating adjusted quantization parameters of all coding tree units in the picture sequence; a seventh syntax element at a picture level, used for indicating adjusted quantization parameters of all coding tree units in the picture; a seventh syntax element at a slice level, used for indicating adjusted quantization parameters of all coding tree units in the slice; and a seventh syntax element at a coding tree unit level, used for indicating an adjusted quantization parameter of the coding tree unit.

In some embodiments, the reference sample information further includes at least one of: a quantization parameter, boundary strength information of a current coding tree unit, reconstructed sample information of a coding tree unit corresponding to the current coding tree unit in a reference picture, a slice type of the current coding tree unit, or partition information of the current coding tree unit.

In practical applications, the inputs of different in-loop filter models may not be exactly the same. A target in-loop filter model and input information of the target in-loop filter model are determined based on a relevant syntax element. In some embodiments, the candidate in-loop filter model includes a first in-loop filter model and a second in-loop filter model; where reference sample information input into the first in-loop filter model further includes: a quantization parameter and boundary strength information of the current coding tree unit; and reference sample information input into the second in-loop filter model further includes: a quantization parameter, reconstructed sample information of a coding tree unit corresponding to the current coding tree unit in a forward reference picture, and reconstructed sample information of a coding tree unit corresponding to the current coding tree unit in a backward reference picture.

Correspondingly, in some embodiments, the method further includes: in a case where the target in-loop filter model is the second in-loop filter model, obtaining a first reference picture of a first reference picture list, and obtaining a first reference picture of a second reference picture list; in a case where the first reference picture of the first reference picture list and the first reference picture of the second reference picture list are a same picture, obtaining a second reference picture of the first reference picture list or a second reference picture of the second reference picture list; using an obtained reference picture of the first reference picture list as the forward reference picture, and using an obtained reference picture of the second reference picture list as the backward reference picture.

For the input part of the second in-loop filter model with multiple reference pictures input, a duplicate checking operation may be performed on the first reference picture and the second reference picture that are input to avoid inputting two piece of identical coding tree unit information. If the two reference pictures are the same, a second candidate picture of the second reference picture list may be obtained as an input of the second reference picture; a third candidate picture of the second reference picture list may also be obtained as the input of the second reference picture. Similarly, the second candidate picture in the first reference picture list may also be obtained as an input of the first reference picture. The present disclosure will not elaborate this further here.

Exemplarily, in some embodiments, the method further includes: in a case where a temporal layer of the current coding tree unit is greater than or equal to a temporal layer threshold, determining that the target in-loop filter model of the current coding tree unit is a second in-loop filter model; and in a case where the temporal layer of the current coding tree unit is less than the temporal layer threshold, determining, based on the relevant syntax element, the target in-loop filter model of the current coding tree unit from the candidate in-loop filter models based on neural network.

Exemplarily, in some embodiments, the current coding tree unit is a largest coding unit, or the current coding tree unit is obtained by performing a scale change on the largest coding unit. That is, patchWidth and patchHeight are block sizes input into the model, which may be the size of the coding tree unit or a larger patch block after the coding tree unit is padded outward.

The schemes of exploration of the neural network-based in-loop filter are mainly concentrated in two forms. The first form is a multi-model switchable scheme; and the second form is a single model scheme. These two schemes serve as baseline schemes for the in-loop filter based on neural network. The reference software that integrates these two schemes are named as the neural network based video coding reference software (NNVC). All proposals relevant to neural networks must use NNVC as a benchmark for performance and complexity comparison. It is worth mentioning that the basic processing unit of the in-loop filter based on neural network scheme is the coding tree unit, that is, the largest coding unit size.

The biggest difference between the first form of multi-model switchable scheme and the second form of single-model scheme is that the multi-model may provide better performance than the single model for different disclosure scenarios or configuration conditions; but the most apparent disadvantage of the multi-model is that multiple models need to be stored, and a large number of models need to be loaded during computational inference.

The specific first form of multi-model scheme is illustrated in FIG. 4. The framework of a neural network-based in-loop filter mainly consists of an input part, a main network part and an output part. The main inference, as illustrated in the figure includes connecting multiple ARblocks via 3×3 convolutions, finally undergoing a 3×3 convolution operation and performing a shuffle operation on the data. The 2N×2N input is generally a size of a coding tree unit, but in some specific implementations or methods, the boundary pixels are often copied outward, commonly known as a padding operation. This is because as illustrated in the figure above, if the 3×3 convolutional neural network needs to perform a convolution operation on the boundary, the 3×3 convolutional neural network needs to expand outward, otherwise the convolution cannot be performed. It is worth noting that the design of the Attention Residual block illustrated in FIG. 5 may be different in different implementations and methods. The numbers and designs here are only for the convenience of understanding the entire framework of the neural network-based in-loop filter.

As for the Attention Residual block, the Attention Residual block is a combined module consisting of multiple convolutional layers Conv., activation layers PReLU, and attention focusing mechanism layers. The present disclosure does not provide a detailed introduction to the various operation layers in the Attention Residual block. Whether these combination modules are used, how much these combination modules are used, and internal structures of these combination modules do not have a significant impact on the technology to be proposed in the present disclosure. It should be pointed out that whether using the Attention Residual block illustrated in FIG. 5 or other Resblocks, etc., these are all applicable to the solution to be proposed in the present disclosure.

As for the input part, the input part, currently mainly includes reconstructed sample data rec, predicted sample data pred, quantization parameter information QP, and boundary strength information BS, etc. For different slice types, such as intra I_Slice and dual reference picture B_Slice, different models may be used, and the input part may be different. Specifically, for example, the I_Slice model may have one more partition information as an input. For different color components, there may be different applicable models, in this case, the input information may also be different. Specifically, for example, the model of chroma component generally not only need to input reconstructed sample data rec of a chroma component for example, but also need to input reconstructed sample data rec of a luma component, so as to improve the filtering performance.

As for the output part, the output part is basically the residual information res of the current coding tree unit or the reconstructed sample information rec of the current coding tree unit.

As introduced above, for different filtering objects such as luma and chroma, the multi-model scheme may train a model for luma separately, and then train a model for chroma separately; such as I_Slice and B_Slice, the multi-model scheme may train a model for I_Slice, and then train a model for B_Slice separately. Specifically, there are four models in the current mainstream solution, corresponding to luma I_Slice, luma B_Slice, chroma I_Slice, and chroma B_Slice.

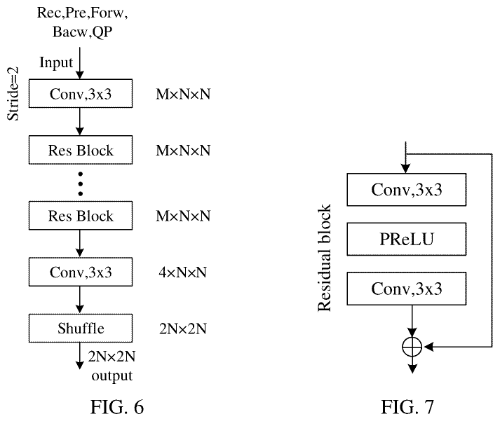

The embodiment of the present disclosure also provides another form of multi-model scheme as illustrated in FIG. 6. The framework of the in-loop filter model based on neural network mainly consists of an input part, a main network part and an output part, where the main inference, as illustrated in FIG. 6, includes connecting multiple Resblocks via 3×3 convolutions, finally undergoing a 3×3 convolution operation and performing a shuffle operation on the data. FIG. 6 is an alternative model for the original B_Slice model illustrated in FIG. 4. FIG. 6 is called the Alter_B_Slice model. There are four models in the first form of multi-model scheme, including a luma I_Slice, a luma B_Slice, a chroma I_Slice and a chroma B_Slice. The Alter_B_Slice model may replace the luma B_Slice, the chroma B_Slice, or both of the luma B_Slice and the chroma B_Slice. However, the replacement is not for all B_slice type pictures or slices, but for some pictures or slices.

According to existing knowledge, a B_Slice type picture or slice may refer to multiple decoded pictures or slices, and in a group of pictures (GOP), the B_Slice picture or slice has different temporal layers according to the distances of the decoded pictures or slices allowed to be referenced. The Alter_B_Slice model may be used in pictures or slices at a higher layer, while the original B_Slice model is used for pictures or slices at other temporal layers.

FIG. 7 is a design scheme of a residual block. It should be noted that the numbers and designs here are only for the convenience of understanding the entire framework of the neural network-based in-loop filter, which may be different in different implementations and methods.

The use conditions of the Alter_B_Slice model illustrated in FIG. 6 and the original B_Slice model illustrated in FIG. 4 are as described above. Further, which one of the Alter_B_Slice model illustrated in FIG. 6 and the original B_Slice model illustrated in FIG. 4 is used for the current picture or slice is determined based on different temporal layers. The Alter_B_Slice model is used for pictures or slices at a higher layer, while the original B_Slice model is used for the pictures or slices at a lower layer, where the higher layer may be set for pictures or slices greater than or equal to Temporal Layer ID 3 (TiD 3), and the lower layer is for the remaining IDs, such as TiD 0, TiD 1 or TiD 2. This is only for convenience of understanding. In practical applications, the number of the temporal layer may be any number within the range allowed by the standard.

The difference between the Alter_B_Slice model and the original B_Slice model lies in the input part. By comparing with the original B_Slice model, it may be found that the Alter_B_Slice model removes the boundary strength information BS, retains the reconstructed samples rec, the predicted samples pred, and the quantization parameter information QP. In addition, the Alter_B_Slice model also adds a forward reference picture Forw and a backward reference picture Bacw as the input information of the model to increase the filtering capability of the in-loop filter model based on neural network at the temporal layer. Here, the forward reference picture and the backward reference picture may be defined as being obtained from two reference picture lists allowed by the standard. For example, the forward reference picture may be the first reference picture of the first reference picture list, and the backward reference picture may be the first reference picture of the second reference picture list.

Exemplarily, the candidate in-loop filter models include a first in-loop filter model and a second in-loop filter model. The first in-loop filter model may be an original in-loop filter model B_Slice model, and the second in-loop filter model may be understood as an alternative in-loop filter model Alter_B_Slice model. In a case where it is determined that the Alter_B_Slice model is allowed to be used, the target in-loop filter model is further determined based on the relevant syntax element. In a case where it is determined that the Alter_B_Slice model is not allowed to be used, other in-loop filter models are further determined based on the relevant syntax element, or it is determined to use other filtering technologies.

In some embodiments, the candidate in-loop filter models may further include an I_Slice model. In some embodiments, the I_Slice model specifically includes a luma I_Slice model and a chroma I_Slice model.

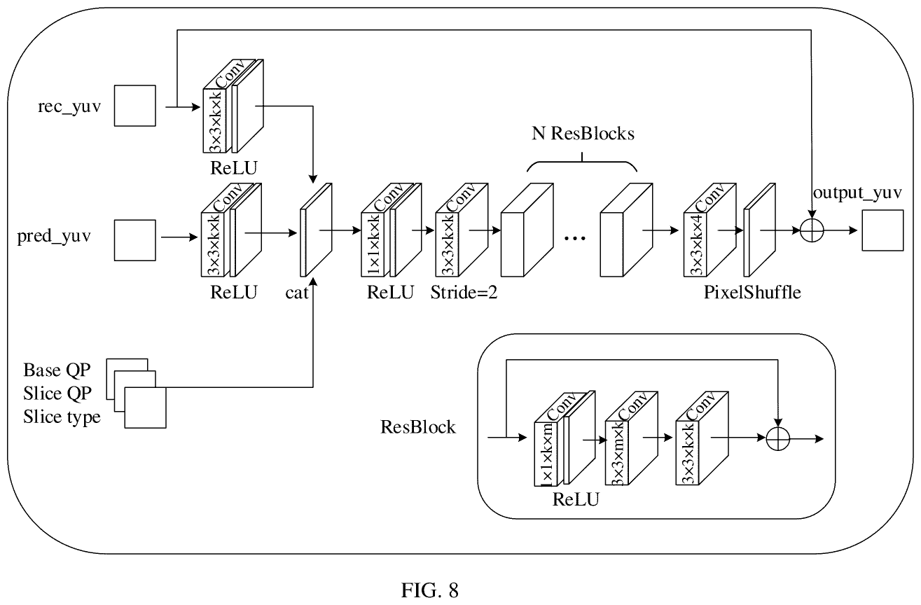

In some embodiments, the candidate in-loop filter model may further include a single model. The embodiment of the present disclosure also provides a single model scheme as illustrated in FIG. 8. The input and filter size of the single model scheme are the same as those of the two forms of multi-model schemes mentioned above, but it is apparent that the combination block used in this scheme is different from combination blocks in the previous two schemes. The combination block used here is ResBlock. As illustrated in FIG. 8, ResBlock is mainly composed of a 1×1×K×K Conv. convolution layer, a ReLU activation layer followed by a 1×1×K×K Conv. convolution layer, and 3×3×K×K Conv. convolution layers. It should be noted that both the ARblock of the first form of multi-model scheme and the ResBlock of the second form of multi-model scheme and the single-model scheme have skip connections, that is, the input and output are connected in the combination block.

For the input part, input types of the single model scheme mainly consist of reconstructed samples rec, predicted samples pred, and three constant input which are base quantization parameter information BaseQP, slice-level quantization parameter information SliceQP, and slice type Slicetype. Here, “slice” may be broadly understood as the picture level or the image level. Since a single model may process different color components and different picture types, the input part needs to input these information at one time to help the neural network better filter the current coding tree unit. Therefore, the reconstructed samples rec include luma reconstructed samples rec and chroma reconstructed samples rec, the predicted samples pred include luma predicted samples pred and chroma predicted samples pred, and the slice type Slicetype indicates that the current coding tree unit is of I_Slice type, B_Slice type or even other types.

For the output part, in the single model, if the single model is a luma model, the output is the luma reconstructed sample rec or the luma residual information res, and if the single model is a chroma model, the output is the chroma reconstructed sample rec or the chroma residual information res. For the single model scheme, the reconstructed samples rec containing luma and chroma or residual information res containing luma and chroma are directly output.

In summary, the main differences in the main frameworks of the three models lie in the input part and the number of models. The present disclosure does not make any specific limitations on the main part of the neural network model. In addition to the above three structures, convolutions such as depth-separable convolutions may also be used to replace the above convolution operations.

In the specific process of training and using the model, due to the generalization of the model and the fact that the model training input includes quantization parameter information, in a case where the model is used to infer a filtered coding tree unit, different filtering results may be obtained by adjusting these input parameter information. Based on these different filtering results, an encoding end selects the optimal parameter based on the principle of minimum rate distortion, signals (or writes) the optimal parameter into the bitstream at a picture level, a slice level, or a coding tree unit level and transmits the optimal parameters. A decoding end obtains these adjusted parameter information by parsing the bitstream, performs the same adjustment operation as the encoding end, and obtains the same filtering result as the encoding end. This section is summarized as model input parameter adjustment.

In addition, a scaling operation is generally performed on the filtered reconstructed samples rec. A scaling factor is obtained at the encoding end by the global minimum mean square error method or other methods that obtain a minimum error among the original sample, the reconstructed sample after being filtered by the neural network, and the reconstructed sample before being filtered by calculating certain square error. The scaling factor is signaled into the bitstream at a slice level, a coding tree unit level, or other combined partition areas and transmitted to the decoding end. The decoding end obtains the same scaling factor as the encoding end by parsing the bitstream and scales the filtered reconstructed sample rec to obtain the final reconstructed sample rec of the coding tree unit. The specific scaling operation is as follows:

$${rec}_{refine} = ( {rec}_{cnn} - {rec}_{before} ) * scale\_factor + {rec}_{before} ,$$

where rec_{refine} is the reconstructed sample after scaling, rec_{cnn} is the reconstructed sample after being filtered by the neural network, rec_{before} is the reconstructed sample before being filtered by the neural network, and scale_factor is the scaling factor. It is worth pointing out that the above is a theoretical calculation process, and the specific implementation includes using some shift operations to replace multiplication operations, etc.

The decoding method is further illustrated below with examples. The decoding end parses a sequence level flag sps_nnlf_enable_flag (i.e., the fifth syntax element). If the sps_nnlf_enable_flag is true, it indicates that the neural network-based in-loop filter technology is allowed to be enabled (used) for the current bitstream, and it is necessary to parse the relevant syntax element in the subsequent decoding process; otherwise, it indicates that the neural network-based in-loop filter technology is not allowed to be enabled (used) for the current bitstream, and no need to parse the relevant syntax element in the subsequent decoding process, and the relevant syntax element is the initial value or the false state by default.

If the sps_nnlf_enable_flag is true, the sps_nnlf_alter_enable_flag relevant to the technology proposed in the present disclosure is parsed, otherwise the sps_nnlf_alter_enable_flag is set to false; if there is no syntax element information relevant to the sps_nnlf_enable_flag in a bitstream, the sps_nnlf_enable_flag is also set to false by default.

1. If the sps_nnlf_enable_flag is true, a decoder parses the syntax elements relevant to the neural network-based in-loop filter technology of the current picture or slice, and obtains the picture or slice level flag slice_nnlf_flag based on the neural network-based in-loop filter technology; otherwise, all neural network-based in-loop filter flags relevant to the technology indicated by the sequence level are set to default values, and the step 3 is performed.

If the sps_nnlf_alter_enable_flag is true (i.e., determined based on a value of the second syntax element) and the current picture or the slice type is B_Slice (i.e., determined based on a value of the fourth syntax element) and slice_nnlf_flag is not 0 (i.e., determined based on a value of the third syntax element), the decoder parses the relevant syntax element of the technology proposed in the present disclosure at the current picture level or the slice level to obtain the picture level flag or slice level flag slice_Alter_B_flag (i.e., the first syntax element); otherwise, the picture level flag or slice level flag slice_Alter_B_flag is set to false; if there is no slice_Alter_B_flag relevant syntax element bitstream information in the bitstream, the slice_Alter_B_flag is false by default.

2. If slice_nnlf_flag is 0, it indicates that the neural network-based in-loop filter technology is enabled (used) for all coding tree units in the current picture or slice, and the step 3 is performed.

If slice_nnlf_flag is 1, it indicates that the neural network-based in-loop filter technology is enabled for all coding tree units in the current picture or slice for filtering, and the usage flag ctb_nnlf_flag of all coding tree units in the current picture or slice are all set to true. If the current picture or slice type is B_Slice, the current picture or slice needs to indicate the loaded model according to slice_Alter_B_flag, otherwise the model may be loaded according to the original rules. The loaded neural network-based in-loop filter model is used to filter all coding tree units. If the model is the Alter_B_Slice model, the reconstructed sample rec, the predicted sample pred, the quantization parameter QP, the reconstructed samples Forw at the corresponding position in the first reference picture, and the reconstructed sample Bacw at the corresponding position in the second reference picture of the current coding tree unit are input into the Alter_B_Slice model for inference to obtain the filtered reconstructed samples of the current coding tree unit. If the model is the original B_Slice model, the reconstructed samples rec, the predicted sample pred, the quantization parameter QP and the boundary strength BS of the current coding tree unit are input into the original B_Slice model for inference to obtain the filtered reconstructed samples of the current coding tree unit. If the loaded model is other models, the specified relevant information is input into the model for inference to obtain the filtered reconstructed samples, which will not be elaborated in detail in the present disclosure.

If slice_nnlf_flag is 2, it indicates that the neural network-based in-loop filter technology is enabled (used) for some coding tree units in the current picture or slice, and the neural network-based in-loop filter technology is not enabled (used) for some other coding tree units in the current picture or slice. It is necessary to further parse the coding tree unit level usage flag ctb_nnlf_flag of all coding tree units in the current picture or slice. If the current picture or slice type is B_Slice, it is necessary to indicate the loaded model according to slice_Alter_B_flag for the current picture or slice, otherwise, the model may be loaded according to the original rules. Traversing all coding tree units in the current picture or slice, if ctb_nnlf_flag is true, the loaded model is used to filter the coding tree unit; and if ctb_nnlf_flag is false, the coding unit does not be filtered. The filtering operation on the coding tree unit is the same as described above and will not be repeated here.

After traversing all coding tree units in the current picture or slice, the neural network-based in-loop filter module ends.

3. The decoding end continues to traverse other in-loop filter tools and outputs a complete reconstructed picture after completion of the traverse. The specific process is not relevant to the technology in the present disclosure, so it will not be elaborated here. The parsing process at the decoding end is illustrated in Table 1.

Table 1 is a brief description of the analysis process at decoding end.

| | |
|---|---|
| if (sps_nnlf_enable_flag) | |
| { | |
| slice_nnlf_flag // Parse picture level or slice level flag | ae(v) |
| if (slice_nnlf_flag != 0) // Enable neural network-based in-loop filter | |
| { | |
| if (slice_nnlf_flag == 1) { // All coding tree units in the current picture or | |
| slice are filtered | |
| for (traverse all ctbs){ | |
| ctb_nnlf_flag = 1 // No parsing required, all true by default | |
| } | |
| } // if (slice_nnlf_flag == 1) | |
| else{ // Not all of coding tree units in the current picture or slice are | |
| filtered | |
| for (traverse all ctbs){ | |
| ctb_nnlf_flag // Parse the coding tree unit level flag | ae(v) |
| } | |
| } | |
| if (slice_type == B_Slice) { // B picture or slice needs to be parsed to | |
| determine if the replaced model is enabled | |
| slice_Alter_B_flag | ae(v) |
| } | |
| else { | |
| slice_Alter_B_flag = 0 | |
| } | |
| } // if (slice_nnlf_flag != 0) The following is the first case | |
| else { // All coding tree units in the current picture or slice are not filtered | |
| for (traverse all ctbs){ | |
| ctb_nnlf_flag = 0 // No parsing required, all false by default | |
| } | |
| } | |
| } // sps | |

In this embodiment, different quantization parameters may be selected at a coding tree unit level, and the quantization parameter is generally used as a constant input of the model. This embodiment focuses on how the adjustment of the quantization parameter and the selection of the model may be combined.

Specifically, the quantization parameter BaseQP input into the model is adjusted according to a preset step size/bias value/compensation value/candidate value. This embodiment takes the compensation value as an example, and the adjustment calculation is as follows:

$$FinalBaseQP = BaseQP + offset ,$$

in the above calculation formula, FinalBaseQP is the quantization parameter BaseQP information finally input into the model, and offset is the quantization parameter compensation value (i.e., adjusted parameter), which may be 0, +5, −5, +10, and −10, etc.

A decoding end parses a sequence level flag. If sps_nnlf_enable_flag is true, it indicates that the neural network-based in-loop filter technology is allowed to be enabled for the current bitstream, and it is necessary to parse the relevant syntax element in the subsequent decoding process; otherwise, it indicates that the neural network-based in-loop filter technology is not allowed to be enabled for the current bitstream, and no need to parse the relevant syntax element the subsequent decoding process. The relevant syntax element is the initial value or the false state by default.

If sps_nnlf_enable_flag is true, the sps_nnlf_alter_enable_flag relevant to the technology proposed in the present disclosure is parsed, otherwise the sps_nnlf_alter_enable_flag is set to false; if there is no syntax element information relevant to the sps_nnlf_enable_flag in the bitstream, the sps_nnlf_enable_flag is also set to false by default.

1. If sps_nnlf_enable_flag is true, the decoder parses the syntax elements relevant to the neural network-based in-loop filter technology of the current picture or slice, and obtains the picture or slice level flag slice_nnlf_flag based on the neural network-based in-loop filter technology; otherwise, all neural network-based in-loop filter flags relevant to the technology indicated by the sequence level are set to default values, and the step 3 is performed.

If sps_nnlf_alter_enable_flag is true and the current picture or slice type is B_Slice and slice_nnlf_flag is not 0, the decoder parses the relevant syntax element of the technology proposed in the present disclosure at the current picture or slice level to obtain the picture or slice level flag slice_Alter_B_flag; otherwise, the picture or slice level flag slice_Alter_B_flag is set to false; if there is no slice_Alter_B_flag relevant syntax element bitstream information in the bitstream, the slice_Alter_B_flag is false by default.

2. If slice_nnlf_flag is 0, it indicates that the neural network-based in-loop filter technology is not enabled (used) for all coding tree units in the current picture or slice, and the step 3 is performed.

If slice_nnlf_flag is 1, it indicates that the neural network-based in-loop filter technology is enabled for all coding tree units in the current picture or slice. The picture level or slice level neural network-based in-loop filter input adjusted parameter slice_nnlf_param in the parsed bitstream is used to indicate whether to modify the input quantization parameter information, and all usage flags ctb_nnlf_flag of all coding tree units in the current picture or slice are set to true. If the current picture or slice type is B_Slice, it is necessary to indicate the loaded model according to slice_Alter_B_flag for the current picture or slice; otherwise, the model may be loaded according to the original rules. The neural network-based loaded in-loop filter model is used to filter all coding tree units; if the model is the Alter_B_Slice model, the reconstructed sample rec, the predicted sample pred, the quantization parameter QP (adjusted according to the seventh syntax element slice_nnlf_param at a picture level or slice level), the reconstructed sample information Forw at the corresponding position in a first reference picture, and the reconstructed sample information Bacw at the corresponding position in a second reference picture of the current coding unit are input into the Alter_B_Slice model for inference to obtain the filtered reconstructed sample of the current coding tree unit. If the model is the original B_Slice model, the reconstructed sample rec, predicted sample pred, quantization parameter QP (adjusted according to the slice_nnlf_param indication) and boundary strength BS of the current coding tree unit are input into the original B_Slice model for inference to obtain the filtered reconstructed sample of the current coding tree unit. If the model is other models, the specified relevant information is input into the model for inference to obtain the filtered reconstructed samples, which will not be elaborated in detail in the present disclosure. All coding tree units in the current picture or slice are filtered.

If slice_nnlf_flag is 2, it indicates that the neural network-based in-loop filter technology is enabled for some coding tree units in the current picture or slice, and the neural network-based in-loop filter technology is enabled for some other coding tree units in the current picture or slice. It is necessary to parse usage flag ctb_nnlf_flag of all coding tree units at the coding tree unit level in the current picture or slice, and parse the bitstream according to the true or false of ctb_nnlf_flag. If the ctb_nnlf_flag of the current coding tree unit is true, the bitstream is parsed to obtain the ctb_nnlf_param information. Otherwise, ctb_nnlf_param does not exist by default and its variable value is 0. If the current picture or slice type is B_Slice, the current picture or slice needs to indicate the loaded model according to slice_Alter_B_flag, otherwise, the model may be loaded according to the original rules. Traversing all coding tree units in the current picture or slice, if ctb_nnlf_flag is true, the loaded model is used to filter the coding tree unit, and the quantization parameter information of the input part needs to be adjusted according to ctb_nnlf_param; and if ctb_nnlf_flag is false, the coding unit does not be filtered. The filtering operation on the coding tree unit is the same as described above and will not be repeated here.

In some embodiments, the quantization parameter QP may also be adjusted according to the sixth syntax element slice_nnlf_param_flag and seventh syntax element slice_nnlf_param at a picture level or slice level, or the quantization parameter QP may also be adjusted according to the sixth syntax element slice_nnlf_param_flag at a picture level or slice level and the seventh syntax element ctb_nnlf_param at a coding tree unit level.

After traversing all coding tree units in the current picture or slice, the neural network-based in-loop filter module ends.

3. The decoding end continues to traverse other in-loop filter tools and outputs a complete reconstructed picture after completion of the traverse. The specific process is not relevant to the technology in the present disclosure, so it will not be elaborated here. The parsing process at the decoding end is illustrated in Table 2.

Table 2 is a brief description of the parsing process at the decoding end

| | |
|---|---|
| if (sps_nnlf_enable_flag) | |
| { | |
| slice_nnlf_flag // Parse picture level or slice level flag | ae(v) |
| if (slice_nnlf_flag != 0) // Enable neural network-based in-loop filter | |
| { | |
| if (slice_nnlf_flag == 1) { // All coding tree units in the current picture | |
| or slice are filtered | |
| slice_nnlf_param // Parse a parameter index at the picture level or | ae(v) |
| slice level | |
| for (traverse all ctbs){ | |
| ctb_nnlf_flag = 1 // No parsing required, all are true by default | |
| ctb_nnlf_param = slice_nnlf_param // No parsing required, all | |
| are consistent | |
| } | |
| } // if (slice_nnlf_flag == 1) | |
| else{ // Not all of coding tree units in the current picture or slice are | |
| filtered | |
| for (traverse all ctbs){ | |
| ctb_nnlf_flag // Parse the coding tree unit level flag | ae(v) |
| ctb_nnlf_param // Parse the coding tree unit level parameter | ae(v) |
| index | |
| } | |
| } | |
| if (slice_type == B_Slice) { // B picture or slice needs to be parsed to | |
| determine if the replaced model is enabled | |
| slice_Alter_B_flag | ae(v) |
| } | |
| else { | |
| slice Alter_B_flag = 0 | |
| } | |
| } // if (slice_nnlf_flag != 0) The following is the first case | |
| else { // All coding tree units in the current picture or slice are not filtered | |
| for (traverse all ctbs){ | |
| ctb_nnlf_flag = 0 // No parsing required, all are false by default | |
| ctb_nnlf_param = 0 // No parsing required, all are initial values | |
| } | |
| } | |
| } // sps | |

In some embodiments, in addition to adjusting quantization parameters, other input parts may also be adjusted. For example, geometric transform is performed on non-constant parameters, such as input reconstructed sample information and predicted sample information. Exemplarily, the geometric transform includes: diagonal flipping, horizontal flipping, vertical flipping, rotating by a preset angle, etc., or a combination of the two. Specifically, if the value of the seventh syntax element that adjusts the parameter is 0, it indicates no adjustment is made; if it is 1, the quantization parameter is adjusted; and if it is 2, the reconstructed sample information and the predicted sample information are horizontally flipped.

An encoding end selects a target in-loop filter model corresponding to the smallest distortion cost value. The usage situation of an in-loop filter model needs to be identified by a new syntax element and needs to be signaled into a bitstream for being transmitted to a decoding end. The decoding end only needs to parse the bitstream and select the best target in-loop filter model for the current coding tree unit based on the relevant syntax element.

An input duplicate checking operation is performed on an in-loop filter model (such as, Alter_B_Slice) with multiple reference pictures input to ensure that a reference picture obtained from a first reference picture list and a reference picture obtained from a second reference picture list are different reference pictures.

The usage situation of the model is decided according to the temporal layer, which coexists with the method of selecting a target in-loop filter model by the distortion cost value at the encoding end. That is, the picture or slice at a high temporal layer uses the preset second in-loop filter model (such as Alter_B_Slice) by default, while the picture or slice at a non-high temporal layer needs to be decided by optimizing the distortion cost value at the encoding end and represented by the relevant syntax element.

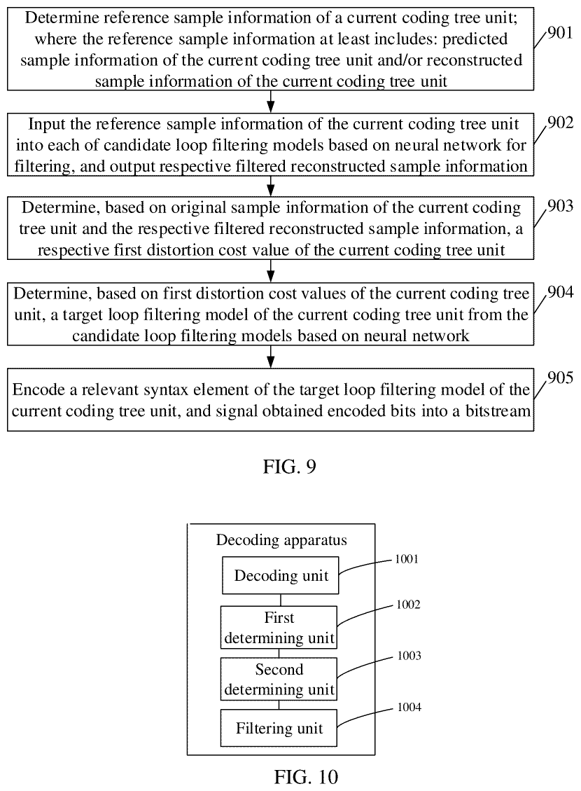

The embodiments of the present disclosure also provide an encoding method. In one embodiment of the present disclosure, FIG. 9 is a flowchart of an encoding method provided in the embodiments of the present disclosure. As illustrated in FIG. 9, the method may include a step 901, a step 902, a step 903, a step 904 and a step 905.

In the step 901, reference sample information of the current coding tree unit is determined; where the reference sample information at least includes: predicted sample information of the current coding tree unit and/or reconstructed sample information of the current coding tree unit;

The intra prediction or inter prediction is used for a current block to generate a prediction block of the current block, and a prediction block of the coding tree unit (i.e., predicted sample information) is composed according to the prediction block of the current block. On the other hand, a bitstream is parsed to get a quantization coefficient matrix, inverse quantization and inverse transform are performed on the quantization coefficient matrix to get a residual block, and the prediction block and the residual block are summed to get a reconstructed block. Reconstructed blocks form a reconstructed picture (i.e., reconstructed sample information) of the coding tree unit, and in-loop filtering is performed on the reconstructed picture to obtain a decoded picture by taking the coding tree unit (i.e., the largest coding unit size.) as a basic processing unit.

In the step 902, the reference sample information of the current coding tree unit is input into each of candidate in-loop filter models based on neural network for filtering, to output respective filtered reconstructed sample information.

Exemplarily, the reference sample information further includes at least one of: a quantization parameter, boundary strength information of the current coding tree unit, reconstructed sample information of a coding tree unit corresponding to the current coding tree unit in a reference picture, a slice type of the current coding tree unit, or partition information of the current coding tree unit.

In practical applications, the inputs of different in-loop filter models may not be exactly the same. A target in-loop filter model and input information of the target in-loop filter model are determined based on a relevant syntax element. In some embodiments, the candidate in-loop filter model includes a first in-loop filter model and a second in-loop filter model; where reference sample information input into the first in-loop filter model further includes: a quantization parameter and boundary strength information of the current coding tree unit; reference sample information input into the second in-loop filter model further includes: a quantization parameter, reconstructed sample information of a coding tree unit corresponding to the current coding tree unit in a forward reference picture, and reconstructed sample information of a coding tree unit corresponding to the current coding tree unit in a backward reference picture.

In the step 903, a respective first distortion cost value of the current coding tree unit is determined based on original sample information of the current coding tree unit and the respective filtered reconstructed sample information.

In the step 904, based on first distortion cost values of the current coding tree unit, a target in-loop filter model of the current coding tree unit is determined from the candidate in-loop filter models based on neural network.

In some embodiments, determining, based on the first distortion cost values of the current coding tree unit, the target in-loop filter model of the current coding tree unit from the candidate in-loop filter models based on neural network includes: determining a first distortion cost value of a current picture block by accumulating first distortion cost values of all coding tree units in the current picture block in which the current coding tree unit is located; and determining, based on first distortion cost values of the current picture block corresponding to the candidate in-loop filter models, the target in-loop filter model of the current coding tree unit. Specifically, a in-loop filter model corresponding to a first distortion cost value with the smallest value is selected as the target in-loop filter model. In some embodiments, the first distortion cost value may be a rate distortion cost value.

Exemplarily, the current picture block includes at least one of: a current picture sequence, a current picture, a current slice, or a current coding tree unit. That is, if the current picture block is the current picture sequence, the current picture or the current slice, and the target in-loop filter model of the current picture block is determined based on the accumulated value of the first distortion cost values of all coding tree units in the current picture block; and if the current picture block is a current coding tree unit, and the target in-loop filter model of the current coding tree unit is determined based on the first distortion cost value of the current coding tree unit.

In some embodiments, the method further includes: determining, based on the original sample information of the current coding tree unit and the reconstructed sample information of the reference sample information, a second distortion cost value of the current coding tree unit; determining a second distortion cost value of the current picture block by accumulating second distortion cost values of all coding tree units in the current picture block in which the current coding tree unit is located; and determining, based on a smallest distortion cost value between the first distortion cost values of the current picture block and the second distortion cost value of the current picture block, whether a neural network-based in-loop filter technology is enabled for the current picture block. That is, the second distortion cost value which obtained without using the neural network-based in-loop filter technology and a smallest value among the first distortion cost values corresponding to multiple candidate in-loop filter models based on neural network that are used are calculated, and then a smallest distortion cost value is selected to determine whether the neural network-based in-loop filter technology is enabled for the current picture block.

In the step 905, a relevant syntax element of the target in-loop filter model of the current coding tree unit is encoded, and obtained encoded bits are signaled into a bitstream.

The relevant syntax element is used to indicate the target in-loop filter model of the coding tree unit. The relevant syntax element includes one or more of a sequence level syntax element, a picture level syntax element, a slice level syntax element, and a coding tree unit level syntax element.

Exemplarily, in some embodiments, the relevant syntax element includes a first syntax element. The first syntax element is set based on a target in-loop filter model of a current coding tree unit.

In some embodiments, the first syntax element includes one of: a first syntax element at a picture sequence level, used for indicating target in-loop filter models of all coding tree units in a picture sequence; a first syntax element at a picture level, used for indicating target in-loop filter models of all coding tree units in a picture; a first syntax element at a slice level, used for indicating target in-loop filter models of all coding tree units in a slice; and a first syntax element at a coding tree unit level, used for indicating a target in-loop filter model of a coding tree unit.

Exemplarily, in some embodiments, the relevant syntax element further includes a second syntax element. The method further includes: setting a second syntax element based on whether a second in-loop filter model based on neural network is allowed to be enabled for a current picture block; where the second in-loop filter model is a candidate in-loop filter model other than a first in-loop filter model; and setting the first syntax element based on the target in-loop filter model of the current coding tree unit, in a case where it is determined that the second in-loop filter model based on neural network is enabled for the current picture block in which the current coding tree unit is located.

Exemplarily, the current picture block includes at least one of: a picture sequence in which the current coding tree unit is located, a picture in which the current coding tree unit is located, a slice in which the current coding tree unit is located, or a current picture tree unit.

Exemplarily, the second syntax element includes at least one of: a second syntax element at a picture sequence level, used for indicating whether the second in-loop filter model based on neural network is allowed to be enabled for a picture sequence; a second syntax element at a picture level, used for indicating whether the second in-loop filter model based on neural network is allowed to be enabled for a picture; a second syntax element at a slice level, used for indicating whether the second in-loop filter model based on neural network is allowed to be enabled for a slice; or a second syntax element at a coding tree unit level, used for indicating whether the second in-loop filter model based on neural network is allowed to be enabled for a coding tree unit.

In some embodiments, the second syntax element includes a second syntax element at a picture sequence level. In some embodiments, the second syntax element includes a second syntax element at a picture sequence level and a second syntax element at a picture level. In some embodiments, the second syntax element includes a second syntax element at a picture sequence level and a second syntax element at a slice level. In some embodiments, the second syntax element includes a second syntax element at a picture sequence level, a second syntax element at a picture level (or slice level), and a second syntax element at a coding tree unit level.

Exemplarily, in some embodiments, the relevant syntax element further includes a third syntax element. The method further includes: setting a third syntax element based on whether a neural network-based in-loop filter technology is enabled (used) for a current picture block in which the current coding tree unit is located; and setting the first syntax element based on a target in-loop filter model of the current coding tree unit, in a case where it is determined that the neural network-based in-loop filter technology is enabled for the current picture block where the current coding tree unit is located. In some embodiments, in a case where the third syntax element is a first preset value, it is determined that the neural network-based in-loop filter technology is not enabled for all coding tree units in the current picture block; in a case where the third syntax element is a second preset value, it is determined that the neural network-based in-loop filter technology is enabled for all coding tree units in the current picture block; and in a case where the third syntax element is a third preset value, it is determined that the neural network-based in-loop filter technology is enabled for some coding tree units in the current picture block.

Exemplarily, in some embodiments, the third syntax element includes at least one of: a third syntax element at a picture sequence level, used for indicating whether the neural network-based in-loop filter technology is enabled for a picture sequence; a third syntax element at a picture level, used for indicating whether the neural network-based in-loop filter technology is enabled for a picture; a third syntax element at a slice level, used for indicating whether the neural network-based in-loop filter technology is enabled for a slice; or a third syntax element at a coding tree unit level, used for indicating whether the neural network-based in-loop filter technology is enabled for a coding tree unit.

In some embodiments, the third syntax element includes a third syntax element at a picture sequence level. In some embodiments, the third syntax element includes a third syntax element at a picture sequence level and a third syntax element at a picture level. In some embodiments, the third syntax element includes a third syntax element at a picture sequence level and a third syntax element at a slice level. In some embodiments, the third syntax element includes a third syntax element at a picture sequence level, a third syntax element at a picture level (or a slice level), and a third syntax element at a coding tree unit level.

Exemplarily, in some embodiments, the relevant syntax elements further include a fourth syntax element. The method further includes: setting a fourth syntax element based on a picture type of the current coding tree unit or a slice type of the current coding tree unit; setting, based on the first syntax element, the first syntax element based on the target in-loop filter model of the current coding tree unit, in a case where it is determined that the picture type of the current coding tree unit or the slice type of the current coding tree unit is a preset type. That is, only in a case where the slice type of the current coding tree unit is a preset type, the candidate in-loop filter model based on neural network is allowed to be used for in-loop filter; otherwise, the candidate in-loop filter model based on neural network is not allowed to be used for in-loop filter. In some embodiments, the preset type is B_slice.

In some embodiments, the fourth syntax element includes one of: a fourth syntax element at a picture sequence level, used for indicating a picture type or a slice type of all coding tree units in a picture sequence; a fourth syntax element at a picture level, used for indicating a picture type or a slice type of all coding tree units in a picture; a fourth syntax element at a slice level, used for indicating a picture type or a slice type of all coding tree units in a slice; and a fourth syntax element at a coding tree unit level, used for indicating a picture type or a slice type of a coding tree unit.

In some embodiments, the relevant syntax elements further include a fifth syntax element. The method further includes: setting a fifth syntax element based on whether a neural network-based in-loop filter technology is allowed to be enabled (used) for a current picture block. In a case where it is determined that the neural network-based in-loop filter technology is allowed to be enabled, the in-loop filter technology based on neural network is initialized, the candidate in-loop filter model based on neural network is loaded, distortion cost values are calculated, and the target in-loop filter model is determined; and in a case where it is determined based on the fifth syntax element that the neural network-based in-loop filter technology is not allowed to be enabled, other filtering technologies are enabled, or the filtering technology is not enabled.

In some embodiments, the fifth syntax element includes at least one of: a fifth syntax element at a picture sequence level, used for indicating whether the neural network-based in-loop filter technology is enabled for a picture sequence; a fifth syntax element at a picture level, used for indicating whether the neural network-based in-loop filter technology is enabled for a picture; a fifth syntax element at a slice level, used for indicating whether the neural network-based in-loop filter technology is enabled for a slice; or a fifth syntax element at a coding tree unit level, used for indicating whether the neural network-based in-loop filter technology is enabled for a coding tree unit.

In some embodiments, the fifth syntax element includes a fifth syntax element at a picture sequence level. In some embodiments, the fifth syntax element includes a fifth syntax element at a picture sequence level and a fifth syntax element at a picture level. In some embodiments, the fifth syntax element includes a fifth syntax element at a picture sequence level and a fifth syntax element at a slice level. In some embodiments, the fifth syntax element includes a fifth syntax element at a picture sequence level, a fifth syntax element at a picture level (or a slice level), and a fifth syntax element at a coding tree unit level.

In summary, in a case where it is determined, based on at least one of the second syntax element, the third syntax element, the fourth syntax element, or the fifth syntax element, that a candidate in-loop filter model based on neural network is enabled for the current picture block, a target in-loop filter model is determined based on the first syntax element from the candidate in-loop filter models.

In some embodiments, the reference sample information further includes: candidate quantization parameters; the method further includes: determining, based on the first distortion cost values of the current coding tree unit, a target quantization parameter of a current picture block in which the current coding tree unit is located from the candidate quantization parameters. That is, the encoding end may select multiple candidate quantization parameters and determine the target quantization parameter of the current coding tree unit by calculating distortion cost values. According to the adjusted parameters of the quantization parameters allowed by the current picture or slice or the adjustment input information of the quantization parameters allowed to be used, due to the difference in input information, the filtered reconstructed samples inferred and obtained by the model are also different.

In some embodiments, the method further includes: determining, based on the target quantization parameter of the current picture block in which the current coding tree unit is located, whether to adjust a quantization parameter of the current picture block in which the current coding tree unit is located, to set a sixth syntax element; and setting a seventh syntax element based on the target quantization parameter of the current picture block in which the current coding tree unit is located, in a case where it is determined to adjust the quantization parameter of the current picture block in which the current coding tree unit is located.

In some embodiments, the sixth syntax element includes at least one of: a sixth syntax element at a picture sequence level, used for indicating whether to adjust a quantization parameter of a coding tree unit in a picture sequence; a sixth syntax element at a picture level, used for indicating whether to adjust a quantization parameter of a coding tree unit in a picture; a sixth syntax element at a slice level, used for indicating whether to adjust a quantization parameter of a coding tree unit in a slice; or a sixth syntax element at a coding tree unit level, used for indicating whether to adjust a quantization parameter of a coding tree unit.

In some embodiments, the sixth syntax element includes a sixth syntax element at a picture sequence level. In some embodiments, the sixth syntax element includes a sixth syntax element at a picture sequence level and a sixth syntax element at a picture level. In some embodiments, the sixth syntax element includes a sixth syntax element at a picture sequence level and a sixth syntax element at a slice level. In some embodiments, the sixth syntax element includes a sixth syntax element at a picture sequence level, a sixth syntax element at a picture level (or a slice level), and a sixth syntax element at a coding tree unit level.

The seventh syntax element includes one of: a seventh syntax element at a picture sequence level, used for indicating adjusted quantization parameters of all coding tree units in the picture sequence; a seventh syntax element at a picture level, used for indicating adjusted quantization parameters of all coding tree units in the picture; a seventh syntax element at a slice level, used for indicating adjusted quantization parameters of all coding tree units in the slice; and a seventh syntax element at a coding tree unit level, used for indicating an adjusted quantization parameter of the coding tree unit.

In some embodiments, the reference sample information further includes at least one of: a quantization parameter, boundary strength information of a current coding tree unit, reconstructed sample information of a coding tree unit corresponding to the current coding tree unit in a reference picture, a slice type of the current coding tree unit, or partition information of the current coding tree unit.

In practical applications, the inputs of different in-loop filter models may not be exactly the same. A target in-loop filter model and input information of the target in-loop filter model are determined based on a relevant syntax element. In some embodiments, the candidate in-loop filter model includes a first in-loop filter model and a second in-loop filter model; where reference sample information input into the first in-loop filter model further includes: a quantization parameter and boundary strength information of the current coding tree unit; and the reference sample information input into the second in-loop filter model further includes: a quantization parameter, reconstructed sample information of a coding tree unit corresponding to the current coding tree unit in a forward reference picture, and reconstructed sample information of a coding tree unit corresponding to the current coding tree unit in a backward reference picture.

Correspondingly, in some embodiments, the method further includes: in a case where the candidate in-loop filter model is the second in-loop filter model, obtaining a first reference picture of a first reference picture list, and obtaining a first reference picture of a second reference picture list; in a case where the first reference picture of the first reference picture list and the first reference picture of the second reference picture list are a same picture, obtaining a second reference picture of the first reference picture list or a second reference picture of the second reference picture list; using an obtained reference picture of the first reference picture list as the forward reference picture, and using an obtained reference picture of the second reference picture list as the backward reference picture.

For the input part of the second in-loop filter model with multiple reference pictures input, a duplicate checking operation may be performed on two reference pictures obtained from two reference picture lists to avoid inputting two piece of identical coding tree unit information. If the two reference pictures are the same, the second candidate picture in the first reference picture list may be obtained as an input; or the second candidate picture in the second reference picture list may be obtained as an input.

In some embodiments, for an in-loop filter model with multiple reference picture input, the selection of a first reference picture and the selection of a second reference picture may be represented by a flag of a syntax element, for example, if the first candidate picture in the first reference picture list is selected, then the flag is set to 1, and if the second candidate picture is selected, then the flag is set to 2. The encoding end performs rate distortion cost optimization to decide which candidate picture in the first reference picture list may be used, and the selection of the second reference picture list is similar.

In some embodiments, for an in-loop filter model with multiple reference pictures input, the candidate picture in the reference picture list have a proximity relationship with the current picture at the temporal domain, and the reference picture closest to the temporal of the current picture may be selected as input at the encoding end and the decoding end at the same time. Specifically, two reference picture lists are traversed, and the candidate picture closest to the current picture is selected as the first reference picture, and the second closest candidate picture is selected as the second reference picture.

Exemplarily, in some embodiments, the method further includes: in a case where a temporal layer of the current coding tree unit is greater than or equal to a temporal layer threshold, determining that the target in-loop filter model of the current coding tree unit is a second in-loop filter model; and in a case where the temporal layer of the current coding tree unit is less than the temporal layer threshold, determining, based on the relevant syntax element, the target in-loop filter model of the current coding tree unit from the candidate in-loop filter models based on neural network. Exemplarily, in a case where an encoding end encodes a picture or slice of a high temporal layer, the encoding end uses the Alter_B_Slice model by default, so that there is no need to signal slice_Alter_B_flag into the bitstream. In a case where a decoding end decodes a picture or slice of a high temporal layer, there is no need to parse the bitstream to obtain the information of slice_Alter_B_flag, the slice_Alter_B_flag is true by default and the Alter_B_Slice model is used.

Exemplarily, in some embodiments, the current coding tree unit is a largest coding unit, or the current coding tree unit is obtained by performing a scale change on the largest coding unit. That is, patchWidth and patchHeight are the block sizes input into the model, which may be the size of the coding tree unit or a larger patch block after the coding tree unit is padded outward.

The present disclosure proposes a selection scheme of the neural network-based in-loop filter. That is, in a case where performing neural network-based in-loop filter on a B_Slice picture or slice, the encoding end selects one model to be applied to the current picture or slice from the Alter_B_Slice model and the B_Slice model, and signals the newly added syntax element that indicates which one of the Alter_B_Slice model or the B_Slice model is selected into the bitstream and transmits the newly added syntax element to the decoding end. The decoding end parses the bitstream and obtains the relevant syntax element, that is, the Alter_B_Slice model or the B_Slice model should be used for the current picture or slice. The above information of using the Alter_B_Slice model or the B_Slice model may be represented at the picture level or the slice level through a new syntax element, such as slice_Alter_B_flag. For the convenience of understanding and writing, the syntax element is recorded as slice_Alter_B_flag, the semantics of which may be expressed as follows: if the flag is zero or false, it indicates that the Alter_B_Slice model is not used for the current picture or slice, and the original B_Slice model is used for the current picture or slice; if the flag is non-zero or true, it indicates that the Alter_B_Slice model is used for the current picture or slice. If there is no slice_Alter_B_flag syntax element in the bitstream, the variable corresponding to the syntax element defaults to zero or false.

The method that the encoding end selects one of the Alter_B_Slice model and the original B_Slice model for the current picture or slice may be that the encoding end uses the original B_Slice model to filter the current picture in the first round and calculates a distortion cost value 1 of the current picture, and uses the Alter_B_Slice model to filter the current picture in the second round and calculates a distortion cost value 2 of the current picture. By comparing the cost values 1 and 2, a better model is selected as the neural network filtering model for the current picture or slice. But it is worth pointing out that there may be different methods for the encoding end, and the present disclosure only lists these methods for easy understanding and writing.

The newly added syntax element for selecting the Alter_B_Slice model or the original B_Slice model may be the picture level or slice level syntax element, which means that the in-loop filter model based on neural network used for the current picture or slice is determined by the variable value corresponding to the syntax element. However, it is worth pointing out that the newly added syntax element may also be a syntax element at a coding tree unit level, which means that the in-loop filter model based on neural network used for the current coding tree unit is determined by the variable value corresponding to the syntax element.

In this embodiment, different quantization parameters may be selected at a coding tree unit level, and the quantization parameter is generally used as a constant input of the model. This embodiment focuses on that the adjustment of the quantization parameter and the selection of the model may be combined.

In addition, in order to improve the cost-effectiveness of the performance and complexity of the model, the present disclosure also proposes maintaining a selection method for replacing the model according to the temporal layer for the B_Slice picture or slice under non-low-latency test conditions, while for B_Slice under low-latency test conditions, the selection is made at the encoding end. Specifically, the encoding end and the decoding end of high temporal layer do not need to parse the newly added syntax element to obtain the model usage information, and the Alter_B_Slice model is used by default; while the encoding end and decoding end of the low temporal layer need to parse the newly added syntax element in the bitstream to obtain the model usage information.

In addition, the present disclosure also proposes a method to improve coding performance, which performs duplicate checking on the reference picture information obtained from the first reference picture list and the reference picture information obtained from the second reference picture list. If the two are the same, that is, the two reference pictures are a same picture, then the second reference picture in the second reference picture list is obtained as the backward reference picture input information of the model. In a case where the two are the same, the second reference picture may be obtained from the first reference picture list as the forward reference picture input information of the model, which will not be repeated here.

The various schemes of the neural network-based in-loop filter proposed in the present disclosure will introduce one or more new syntax elements for selecting in-loop filter models. These syntax elements include but are not limited to the following:
a second syntax element at a picture sequence level sps_nnlf_alter_enable_flag (sequence level enable flag);
a first syntax element at a picture level or slice level slice_Alter_B_flag (picture level flag or slice level flag);
a sixth syntax element at a picture level or slice level slice_nnlf_param_flag (picture level flag or slice level flag); and
a seventh syntax element at a coding tree unit level ctb_nnlf_param (coding tree unit level flag).

The following is a further explanation of an embodiment of the encoding method.

The encoder predicts the current picture to obtain the prediction block of each coding unit, and the residual of the coding unit may be obtained by subtracting the prediction block from the original picture block. The residual is transformed through various transform modes to obtain the frequency domain residual coefficient, which is then quantized and inversely quantized. After inverse transform, the distorted residual information is obtained. The distorted residual information is superimposed on the prediction block to obtain the reconstructed block. The reconstructed block generally refers to a reconstructed sample coding unit obtained by superimposing the predicted sample with the residual sample after inverse transform and inverse quantization. Following this, the in-loop filter module filters the picture by taking a coding tree unit level as the basic unit, and the technology proposed in the present disclosure is applied here.

The coding tree unit enters the neural network-based in-loop filter module and obtains neural network-based in-loop filter enabled usage flag, i.e., sps_nnlf_enable_flag. If the flag is true, the neural network-based in-loop filter technology is allowed to be enabled (used); if the flag is false, the neural network-based in-loop filter technology is not allowed to be enabled. The sequence level enabled usage flag needs to be signaled into the bitstream when encoding a video sequence. Here, in the technology in the present disclosure, a sequence level enable flag may be added, such as adding a new syntax element sps_nnlf_alter_enable_flag. The naming of this syntax element here is mainly for the convenience of understanding and writing. It may be modified in practical applications and standard texts, but its semantic content should be consistent or similar, which indicates that if the sps_nnlf_alter_enable_flag is true, the selection scheme of the in-loop filter model based on neural network proposed in the present disclosure is allowed to be enabled; and if the sps_nnlf_alter_enable_flag is false, the selection scheme of the in-loop filter model based on neural network proposed in the present disclosure is not allowed to be enabled.

1. If the neural network-based in-loop filter enabled usage flag is true, the encoding end tries the neural network-based in-loop filter technology, that is, the encoding end executes 2; and if the neural network-based in-loop filter enabled usage flag is false, the encoding end does not try the neural network-based in-loop filter technology, that is, the encoding end skips 2 and directly executes 3.

2. The encoding end initializes the neural network-based in-loop filter technology and loads the neural network model suitable for the current picture.

### a. Calculate the Cost of Reconstructed Sample

The encoding end calculates cost information in a case where the neural network-based in-loop filter technology is not enabled, that is, the encoding end uses the reconstructed sample of the coding tree unit prepared as the network input and the original picture sample of the coding tree unit to calculate a rate distortion cost value and record the rate distortion cost value which is mainly composed of the absolute error and the number of bits consumed. The encoder traverses and calculates cost information of all coding tree units in the current picture or slice, accumulates the cost information and records the cost information to obtain costRec. The costRec cost information represents the accumulated costs of all coding tree units in the current picture or slice.

### b. Filter and Calculate Costs of the Two Forms of Models

The encoding end tries the neural network-based in-loop filter technology, and inputs a reconstructed sample rec, a predicted sample pred, a quantization parameter QP and boundary strength information BS of the current coding tree unit to into the loaded original B_Slice model for inference. The neural network-based in-loop filter model outputs the reconstructed sample of the current coding tree unit, calculates a rate distortion cost value of the filtered reconstructed sample of the current coding tree unit and the original picture sample and records the rate distortion cost value. The encoder traverses and calculates cost information of all coding tree units in the current picture or slice, accumulates the cost information and records the cost information to obtain costOrgM. Similarly, costOrgM also represents the accumulated costs of all coding tree units in the current picture or slice.

If the current picture or slice type is B_Slice type, the remaining steps are continued to be executed, otherwise the remaining steps are skipped, costOrgM is assigned to costCnn and 2.c is executed.

The encoding end continues to try the neural network-based in-loop filter technology, and inputs the reconstructed sample rec, the predicted sample pred, the quantization parameter QP, the reconstructed sample Forw of the coding tree unit at the corresponding position in the first reference picture, and the reconstructed sample Bacw of the coding tree unit at the corresponding position in the second reference picture are input into the loaded Alter_B_Slice model for inference. The neural network-based in-loop filter model outputs the reconstructed sample of the current coding tree unit, calculates a rate distortion cost value of the filtered reconstructed sample of the current coding tree unit and the original picture sample and records the rate distortion cost value. The encoder traverses and calculates cost information of all coding tree units in the current picture or slice, accumulates the cost information and records the cost information to obtain costAlterM. Similarly, costAlterM also represents accumulated costs of all coding tree units in the current picture or slice.

If costAlterM is smaller than costOrgM, it indicates that the filtering effect of the current picture or slice using the Alter_B_Slice model is better than the filtering effect of the current picture or slice using the original B_Slice model, and the newly added flag slice_Alter_B_flag is set to true; otherwise, it indicates that the filtering effect of the current picture using the original B_Slice model is better than the filtering effect of the current picture using the Alter_B_Slice model, and the newly added flag slice_Alter_B_flag is set to false; the smaller one of costAlterM and costOrgM is assigned to costCnn for easy subsequent understanding and writing.

### c. Decide Final Information of Neural Network-Based In-Loop Filter Module

The encoding end tries to optimize the selection at a coding tree unit level. In the second round, the neural network-based in-loop filter of the encoding end tries to directly assume that the neural network-based in-loop filter technology is used for all coding tree units of the current picture, which is controlled by using a picture level flag slice_nnlf_flag, while the coding tree unit level does not need to transmit the usage flag ctb_nnlf_flag. Currently, the encoding end tries the coding tree unit level enable combination, that is, each coding tree unit has an independent usage flag.

The encoder traverses the coding tree units, compares the cost information of each coding tree unit before filtering using the neural network-based in-loop filter technology and the cost information of each coding tree unit after filtering, if the unfiltered cost information is smaller, the usage flag of the coding tree unit is set to false; otherwise, the usage flag of the coding tree unit is set to true. After the encoder traverses all coding tree units, the encoder accumulates the smallest cost information of various coding tree units to obtain a rate distortion cost value costCtu of the current picture or slice. The costCtu represents the accumulated value of the smallest cost situation of all coding tree units in the current picture or slice, and the model used by the neural network-based in-loop filter technology here is the better model determined in 2.b. By reading the variable information of the slice_Alter_B_flag flag, it may be obtained that the Alter_B_Slice model or the original B_Slice model is more suitable for the current picture or slice.

If costRec is the smallest, it indicates that it is better not to use the neural network-based in-loop filter technology for the current picture or slice. The picture level or slice level flag slice_nnlf_flag is set to 0 and signaled into the bitstream for being transmitted to the decoding end, indicating that the neural network-based in-loop filter technology is not used for all coding tree units in the current picture or slice, and the coding tree unit level flag does not need to be signaled into the bitstream.

If costCnn is the smallest, it indicates that the neural network-based in-loop filter technology is used for all coding tree units in the current picture or slice, and the picture level or slice level flag slice_nnlf_flag is set to 1 and signaled into the bitstream for being transmitted to the decoding end, and the coding unit level flag does not need to be signaled into the bitstream. In addition, if the current picture or slice type is B_Slice, it is also necessary to signal the information of slice_Alter_B_flag into the bitstream for being transmitted to the decoding end to indicate that the Alter_B_Slice model or the original B_Slice model needs to be used for the current picture or slice.

If costCtu is the smallest, it indicates that the neural network-based in-loop filter technology is not used for all coding tree units in the current picture or slice. The picture level or slice level flag slice_nnlf_flag is set to 2 and signaled into the bitstream for being transmitted to the decoding end. The neural network-based in-loop filter technology usage flag ctb_nnlf_flag of each coding tree unit needs to be signaled into the bitstream. In addition, if the current picture or slice type is B_Slice, the information of slice_Alter_B_flag needs to be signaled into the bitstream for being transmitted to the decoding end, to indicate that the Alter_B_Slice model or the original B_Slice model needs to be enabled for the current picture or slice.

3. The encoder continues to try other in-loop filter tools and outputs a complete reconstructed picture after completion of the output. The specific process is not relevant to the technology in the present disclosure, and therefore it will not be explained in detail here.

The encoder predicts the current picture to obtain the prediction block of each coding unit, and the residual of the coding unit may be obtained by subtracting the prediction block from the original picture block. The residual is transformed through various transform modes to obtain the frequency domain residual coefficient, which is then quantized and inversely quantized. After inverse transform, the distorted residual information is obtained. The distorted residual information is superimposed on the prediction block to obtain the reconstructed block. The reconstructed block generally refers to a reconstructed sample coding unit obtained by superimposing the predicted sample with the residual sample after inverse transform and inverse quantization. Following this, the in-loop filter module filters the picture by taking a coding tree unit level as the basic unit, and the technology proposed in the present disclosure is applied here.

The coding tree unit enters the neural network-based in-loop filter module and obtains the neural network-based in-loop filter enabled usage flag, i.e., sps_nnlf_enable_flag. If the flag is true, the neural network-based in-loop filter technology is allowed to be enabled; if the flag is false, the neural network-based in-loop filter technology is not allowed to be enabled. The sequence level enabled usage flag needs to be signaled into the bitstream when encoding a video sequence. Here, in the technology in the present disclosure, a sequence level enable flag may be added, such as adding a new syntax element sps_nnlf_alter_enable_flag. The naming of this syntax element here is mainly for the convenience of understanding and writing. It may be modified in practical applications and standard texts, but its semantic content should be consistent or similar, which indicates that if the sps_nnlf_alter_enable_flag is true, the selection scheme of the in-loop filter model based on neural network proposed in the present disclosure is allowed to be enabled; and if the sps_nnlf_alter_enable_flag is false, the selection scheme of the in-loop filter model based on neural network proposed in the present disclosure is not allowed to be enabled.

1. If the neural network-based in-loop filter enabled usage flag is true, the encoding end tries the neural network-based in-loop filter technology, that is, the encoding end executes 2; and if the neural network-based in-loop filter enabled usage flag is false, the encoding end does not try the neural network-based in-loop filter technology, that is, the encoding end skips 2 and directly executes 3.

2. The encoding end initializes the neural network-based in-loop filter technology and loads the neural network model suitable for the current picture.

### a. Calculate the Cost of Reconstructed Sample

The encoding end calculates cost information in a case where the neural network-based in-loop filter technology is not enabled, that is, the encoding end uses the reconstructed sample of the coding tree unit prepared as the network input and the original picture sample of the coding tree unit to calculate a rate distortion cost value and record the rate distortion cost value which is mainly composed of the absolute error and the number of bits consumed. The encoder traverses and calculates cost information of all coding tree units in the current picture or slice, accumulates the cost information and records the cost information to obtain costRec. The costRec cost information represents the accumulated costs of all coding tree units in the current picture or slice.

### b. Filter and Calculate Costs of the Two Forms of Models

The encoding end tries the neural network-based in-loop filter technology, and inputs a reconstructed sample rec, a predicted sample pred, a quantization parameter QP and boundary strength information BS of the current coding tree unit to into the loaded original B_Slice model for inference. The in-loop filter model based on neural network outputs the reconstructed sample of the current coding tree unit, calculates a rate distortion cost value of the filtered reconstructed sample of the current coding tree unit and the original picture sample and records the rate distortion cost value. The encoder traverses and calculates cost information of all coding tree units in the current picture or slice, accumulates the cost information and records the cost information to obtain costOrgM. Similarly, costOrgM also represents the accumulated costs of all coding tree units in the current picture or slice.

If the current picture or slice type is B_Slice type, the remaining steps are continued to be executed, otherwise the remaining steps are skipped, costOrgM is assigned to costCnn and 2.c is executed.

The encoding end continues to try the neural network-based in-loop filter technology, and inputs the reconstructed sample rec, the predicted sample pred, the quantization parameter QP, the reconstructed sample Forw of the coding tree unit at the corresponding position in the first reference picture, and the reconstructed sample Bacw of the coding tree unit at the corresponding position in the second reference picture are input into the loaded Alter_B_Slice model for inference. The in-loop filter model based on neural network outputs the reconstructed sample of the current coding tree unit, calculates a rate distortion cost value of the filtered reconstructed sample of the current coding tree unit and the original picture sample and records the rate distortion cost value. The encoder traverses and calculates cost information of all coding tree units in the current picture or slice, accumulates the cost information and records the cost information to obtain costAlterM. Similarly, costAlterM also represents accumulated costs of all coding tree units in the current picture or slice.

If costAlterM is smaller than costOrgM, it indicates that the filtering effect of the current picture or slice using the Alter_B_Slice model is better than the filtering effect of the current picture or slice using the original B_Slice model, and the newly added flag slice_Alter_B_flag is set to true; otherwise, it indicates that the filtering effect of the current picture using the original B_Slice model is better than the filtering effect of the current picture using the Alter_B_Slice model, and the newly added flag slice_Alter_B_flag is set to false; the smaller one of costAlterM and costOrgM is assigned to costCnn for easy subsequent understanding and writing.

The above steps are the same as those in the first embodiment, but in the second embodiment, the input part may be adjusted, for example, the quantization parameter QP may be adjusted. The input information of the model is modified according to the QP adjustment parameter allowed by the current picture or slice or the QP parameter allowed to be used. Due to the difference in input information, the filtered reconstructed samples inferred and obtained by the model are also different. In this embodiment, the unadjusted quantization parameter information is recorded as QP0, and the candidate adjusted quantization parameter information is QP1 and QP2. The determined models are used for QP1 and QP2 respectively to obtain rate distortion costs costCnnQP1 and costCnnQP2 of the current picture or slice. The steps are the same as above, and only the quantization parameter information is modified on the input side.

### c. Decide Final Information of Neural Network-Based In-Loop Filter Module

The encoding end tries to optimize the selection at a coding tree unit level. In the second round, the attempt of neural network-based in-loop filter of the encoding end directly assume that the neural network-based in-loop filter technology is enabled for all coding tree units of the current picture, which is controlled by using a picture level flag slice_nnlf_flag, while the coding tree unit level does not need to transmit the usage flag ctb_nnlf_flag. Currently, the coding tree unit level enable combination is attempted, that is, each coding tree unit has an independent usage flag.

The encoder traverses the coding tree units and compares the cost information of each coding tree unit filtered by enabling the neural network-based in-loop filter technology and the cost information of each coding tree unit filtered by not enabling the neural network-based in-loop filter technology. In this case, there are three types of filtered reconstructed sample blocks, the unmodified input quantization parameter QP0, and modified input quantization parameters QP1 and QP2. When comparing the reconstructed sample cost values of various coding tree units, all of them need to be considered. If the unfiltered cost information is smaller, the usage flag of the coding tree unit is set to false; otherwise, the usage flag of the coding tree unit is set to true. At the same time, if the cost of the reconstructed sample of the coding tree unit corresponding to QP0 is the smallest, the parameter flag ctb_nnlf_param of the current coding tree unit is set to 0; if the cost of the reconstructed sample of the coding tree unit corresponding to QP1 is the smallest, the parameter flag ctb_nnlf_param of the current coding tree unit is set to 1; otherwise, that is, the cost of the reconstructed sample of the coding tree unit corresponding to QP2 is the smallest, then the parameter flag ctb_nnlf_param of the current coding tree unit is set to 2.

After the encoder traverses all coding tree units, the encoder accumulates the smallest cost information of various coding tree units to obtain a rate distortion cost value costCtu of the current picture or slice. The costCtu represents the accumulated value of the smallest cost situation of all coding tree units in the current picture or slice, and the model used by the neural network-based in-loop filter technology here is the better model determined in 2.b. By reading the variable information of the slice_Alter_B_flag flag, it may be obtained that the Alter_B_Slice model or the original B_Slice model is more suitable for the current picture or slice.

If costRec is the smallest, it indicates that it is better not to enable the neural network-based in-loop filter technology for the current picture or slice. The picture level or slice level flag slice_nnlf_flag is set to 0 and signaled into the bitstream for being transmitted to the decoding end, indicating that the neural network-based in-loop filter technology is not enabled for all coding tree units in the current picture or slice, and the coding tree unit level flag does not need to be signaled into the bitstream.

If costCnnQP0/QP1/QP2 is the smallest, it indicates that neural network-based in-loop filter technology is enabled for all coding tree units in the current picture or slice, and the picture level or slice level flag slice_nnlf_flag is set to 1 and signaled into the bitstream for being transmitted to the decoding end. The coding unit level flag does not need to be signaled into the bitstream. If costCnnQP0 is the smallest, the picture level or quantization parameter level flag slice_nnlf_param is set to 0 and signaled into the bitstream for being transmitted to the decoding end; if costCnnQP1 is the smallest, the picture level or quantization parameter level flag slice_nnlf_param is set to 1 and signaled into the bitstream for being transmitted to the decoding end. Otherwise, that is, costCnnQP2 is the smallest, the picture level or quantization parameter level flag slice_nnlf_param is set to 2 and signaled into the bitstream for being transmitted to the decoding end. In addition, if the current picture or slice type is B_Slice, it is also necessary to signal slice_Alter_B_flag information into the bitstream for being transmitted to the decoding end to indicate that the Alter_B_Slice model or the original B_Slice model needs to be used for the current picture or slice.

If costCtu is the smallest, it indicates that neural network-based in-loop filter technology is not enabled for all coding tree units in the current picture or slice. The picture level or slice level flag slice_nnlf_flag is set to 2 and signaled into the bitstream for being transmitted to the decoding end. The neural network-based in-loop filter technology usage flag ctb_nnlf_flag of each coding tree unit needs to be signaled into the bitstream; and the quantization parameter modification information index ctb_nnlf_param of each coding tree unit needs to be signaled into the bitstream. In addition, if the current picture or slice type is B_Slice, the information of slice_Alter_B_flag needs to be signaled into the bitstream for being transmitted to the decoding end, to indicate that the Alter_B_Slice model or the original B_Slice model needs to be used for the current picture or slice.

3. The encoder continues to try other in-loop filter tools and outputs a complete reconstructed picture after completion of the output. The specific process is not relevant to the technology in the present disclosure, therefore it will not be explained in detail here.

The embodiment of the present disclosure may also use residual scaling technology. The residual scaling technology is used on the output of the neural network model to scale the residual obtained by subtracting the filtered reconstructed sample output by the neural network model from the unfiltered reconstructed sample.

In all the above embodiments, it is not specified whether it is a luma component or a chroma component. Since the method proposed in the present disclosure is applicable to both the luma component and the chroma component, no limitation is made in the present disclosure. The syntax elements in the text may be clearly seen, for example, ctb_nnlf_flag and slice_nnlf_flag, which may be divided into luma component and chroma component for separate control. It is worth pointing out that, for example, ctb_nnlf_param may be different from the separate control of various color components mentioned above. Here, in order to save bit overhead, the same flag may be used between color components. Specifically, ctb_nnlf_param can simultaneously indicate that the luma component and the chroma component make the same adjustment, which is not elaborated in the present disclosure.

In all the above embodiments, parsing conditions for the picture level or slice level flag slice_Alter_B_flag may be different from those in the above embodiments. Specifically, in a case where the encoding end encodes a picture or slice at a high temporal layer, the encoding end uses the Alter_B_Slice model by default, so there is no need to signal slice_Alter_B_flag into the bitstream. In a case where the decoding end decodes a picture or slice at a high temporal layer, there is no need to parse the bitstream to obtain the information of slice_Alter_B_flag, slice_Alter_B_flag is true by default and the Alter_B_Slice model is used.

In all the above embodiments, for the input part of the Alter_B_Slice model, the first reference picture may be the first candidate picture in the first reference picture list, or the second candidate picture in the first reference picture list, etc.; similarly, the second reference picture may be the first candidate picture in the second reference picture list, or the second candidate picture in the second reference picture list.

In all the above embodiments, for the input part of the Alter_B_Slice model, a duplicate checking operation may be performed on the first reference picture and the second reference picture that are input to avoid inputting two piece of identical coding tree unit information. If the two reference pictures are the same, a second candidate picture in the second reference picture list may be obtained as an input of the second reference picture; or a third candidate picture in the second reference picture list may be obtained as the input of the second reference picture. Similarly, the second candidate picture in the first reference picture list may also be obtained as an input of the first reference picture. The present disclosure will not elaborate this further here.

In all the above embodiments, for the input part of the Alter_B_Slice model, the first reference picture input and/or the second reference picture input may be specified as an I_Slice full intra coding frame (picture). In the inter coding part, I_Slice is often encoded with higher quality parameters so that a reference may be made by the subsequent B_Slice to improve the overall performance. Therefore, I_Slice often contains more high-frequency information than B_Slice, and thus here may specify that the input part of the Alter_B_Slice model is the I_Slice reference picture. The present disclosure does not make any limitations thereto.

In another embodiment of the present disclosure, the embodiments of the present disclosure further provides a bitstream, which is generated by bit encoding according to information to be encoded, where the information to be encoded includes at least: a relevant syntax element of the current coding tree unit.

An encoding end uses candidate in-loop filter modules to filter coding tree units, calculates distortion cost values, determines a target in-loop filter model corresponding to the smallest distortion cost value, signals a relevant syntax element into a bitstream, and a decoding end only needs to parse the bitstream and select the best target in-loop filter model for the current coding tree unit based on the relevant syntax element, thereby improving the filtering performance of the reconstructed samples of the current coding tree unit.

TABLE 3

| | Low Delay B Main 10 | | | | |
|---|---|---|---|---|---|
| | Y | U | V | E n | Dec |
| Class A1 | | | | | |
| Class A2 | | | | | |
| Class B | −0.71% | 0.21% | 0.51% | 106% | 87% |
| Class C | −0.75% | 0.52% | 0.57% | 106% | 81% |
| Class E | −1.63% | −0.39% | 0.02% | 120% | 106% |
| Overall | −0.95% | 0.35% | 0.54% | 110% | 89% |
| Class D | −0.58% | 0.98% | 0.17% | 105% | 80% |
| Class F | −0.67% | 0.53% | 0.19% | 117% | 94% |
| Class TGM | #VALUE! | #VALUE! | #VALUE! | #DIV/0! | #DIV/0! |

From the experimental results, it can be seen that the method proposed in the present disclosure has a performance improvement of nearly 1% for the luma component under the test condition of Low Delay B, and there is no decoding time complexity.

In another embodiment of the present disclosure, FIG. 10 is a schematic diagram of a composition structure of a decoding apparatus provided in the embodiments of the present disclosure. As illustrated in FIG. 10, the decoding apparatus may include:
a decoding unit 1001, configured to decode a bitstream to determine a relevant syntax element of a current coding tree unit;
a first determining unit 1002, configured to determine, based on the relevant syntax element, a target in-loop filter model of the current coding tree unit from candidate in-loop filter models based on neural network;
a second determining unit 1003, configured to determine reference sample information of the current coding tree unit; where the reference sample information at least includes: predicted sample information of the current coding tree unit and/or reconstructed sample information of the current coding tree unit; and
a filtering unit 1004, configured to input the reference sample information of the current coding tree unit into the target in-loop filter model for filtering, to output filtered reconstructed sample information.

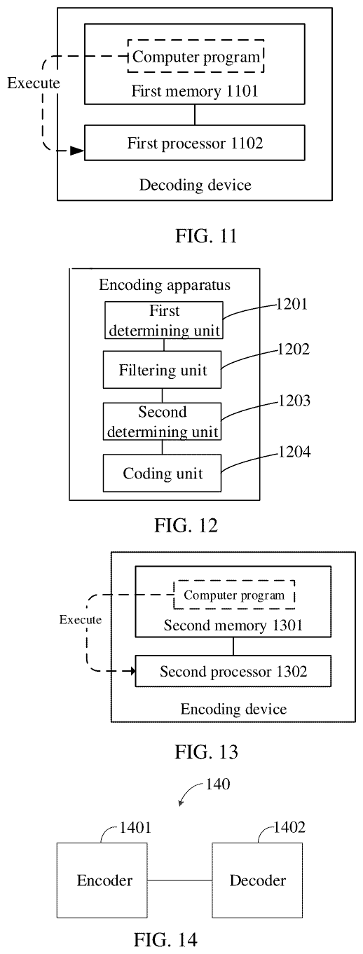

In practical applications, the embodiment of the present disclosure further provides a decoding device. FIG. 11 is a schematic diagram of a specific hardware structure of a decoding device provided in the embodiments of the present disclosure. As illustrated in FIG. 11, the decoding device includes:
a first memory 1101 and a first processor 1102; where the first memory 1101 stores a computer program executable on the first processor 1102, and the first processor 1102 executes the program to implement the encoding method on a encoder side.

In practical applications, the decoding device may further include: a first communication interface, configured to receive and send signals during the process of sending and receiving information with other external network elements.

In another embodiment of the present disclosure, FIG. 12 is a schematic diagram of a composition structure of an encoding apparatus provided in the embodiments of the present disclosure. As illustrated in FIG. 12, the encoding apparatus may include:
a first determining unit 1201, configured to determine reference sample information of a current coding tree unit; where the reference sample information at least includes: predicted sample information of the current coding tree unit and/or reconstructed sample information of the current coding tree unit;
a filtering unit 1202, configured to input the reference sample information of the current coding tree unit into each of candidate in-loop filter models based on neural network for filtering, to output respective filtered reconstructed sample information;
a second determining unit 1203, configured to determine, based on original sample information of the current coding tree unit and the respective filtered reconstructed sample information, a respective first distortion cost value of the current coding tree unit; and determine, based on first distortion cost values of the current coding tree unit, a target in-loop filter model of the current coding tree unit from the candidate in-loop filter models based on neural network; and
a coding unit 1204, configured to encode a relevant syntax element of the target in-loop filter model of the current coding tree unit, and signal obtained encoded bits into a bitstream.

In practical applications, an embodiment of the present disclosure further provides an encoding device. FIG. 13 is a schematic diagram of a specific hardware structure of an encoding device provided in the embodiments of the present disclosure. As illustrated in FIG. 13, the encoding device includes:
a second memory 1301 and a second processor 1302; where the second memory 1301 stores a computer program executable on the second processor 1302, and the second processor 1302 executes the computer program to implement the decoding method on a decoder side.

In practical applications, the encoding device may further include: a second communication interface, configured to receive and send signals during the process of sending and receiving information with other external network elements.

By using the above-mentioned apparatus or device, an encoding end uses candidate in-loop filter modules to filter coding tree units, calculates distortion cost values, determines a target in-loop filter model corresponding to the smallest distortion cost value, signals a relevant syntax element into a bitstream, and a decoding end only needs to parse the bitstream and select the best target in-loop filter model for the current coding tree unit based on the relevant syntax element, thereby improving the filtering performance of the reconstructed samples of the current coding tree unit.

In addition, various functional modules in the embodiment may be integrated into one processing unit, or various units may exist physically separately, or two or more units may be integrated into one unit. The above integrated unit may be implemented in the form of hardware or in the form of a software function module.

In yet another embodiment of the present disclosure, FIG. 14 is a schematic diagram of a composition structure of an encoding and decoding system provided in the embodiments of the present disclosure. As illustrated in FIG. 14, the encoding and decoding system 140 may include an encoder 1401 and a decoder 1402. The encoder 1401 can be a device integrated with the encoding apparatus described in the aforementioned embodiment, or it can also be the encoding device described in the aforementioned embodiment; the decoder 1402 can be a device integrated with the decoding apparatus described in the aforementioned embodiment, or it can also be the decoding device described in the aforementioned embodiment.

In the embodiment of the present disclosure, in the encoding and decoding system 140, an encoding end uses candidate in-loop filter modules to filter coding tree units, calculates distortion cost values, determines a target in-loop filter model corresponding to the smallest distortion cost value, signals a relevant syntax element into a bitstream, and a decoding end only needs to parse the bitstream and select the best target in-loop filter model for the current coding tree unit based on the relevant syntax element, thereby improving the filtering performance of the reconstructed samples of the current coding tree unit.

Correspondingly, an embodiment of the present disclosure further provides a non-transitory computer storage medium, having stored thereon a computer program that, when executed by a first processor, the decoding method of the decoder is implemented; or when executed by a second processor, the encoding method of the encoder is implemented.

In a first clause, provided is a decoding method, and the method includes:
decoding a bitstream to determine a relevant syntax element of a current coding tree unit;
determining, based on the relevant syntax element, a target in-loop filter model of the current coding tree unit from candidate in-loop filter models based on neural network;
determining reference sample information of the current coding tree unit; where the reference sample information at least includes: predicted sample information of the current coding tree unit and/or reconstructed sample information of the current coding tree unit; and
inputting the reference sample information of the current coding tree unit into the target in-loop filter model for filtering, to output filtered reconstructed sample information.

In a second clause, according to the method of the first clause, the method further includes:
determining, based on a first syntax element, the target in-loop filter model of the current coding tree unit from the candidate in-loop filter models based on neural network.

In a third clause, according to the method of the second clause, the first syntax element includes one of:
a first syntax element at a picture sequence level, used for indicating target in-loop filter models of all coding tree units in a picture sequence;
a first syntax element at a picture level, used for indicating target in-loop filter models of all coding tree units in a picture;
a first syntax element at a slice level, used for indicating target in-loop filter models of all coding tree units in a slice; and
a first syntax element at a coding tree unit level, used for indicating a target in-loop filter model of a coding tree unit.

In a fourth clause, according to the method of the second clause, the method further includes:
determining, based on a second syntax element, whether a second in-loop filter model based on neural network is allowed to be enabled for a current picture block in which the current coding tree unit is located; where the second in-loop filter model is a candidate in-loop filter model; and
determining, based on the first syntax element, the target in-loop filter model of the current coding tree unit from the candidate in-loop filter models based on neural network, in a case where it is determined, based on the second syntax element, that the second loop filtering model based on the neural network is enabled for the current picture block in which the current coding tree unit is located.

In a fifth clause, according to the method of the fourth clause, the second syntax element includes at least one of:
a second syntax element at a picture sequence level, used for indicating whether the second in-loop filter model based on neural network is allowed to be enabled for a picture sequence;
a second syntax element at a picture level, used for indicating whether the second in-loop filter model based on neural network is allowed to be enabled for a picture;
a second syntax element at a slice level, used for indicating whether the second in-loop filter model based on neural network is allowed to be enabled for a slice; or
a second syntax element at a coding tree unit level, used for indicating whether the second in-loop filter model based on neural network is allowed to be enabled for a coding tree unit.

In a sixth clause, according to the method of any one of the second to fifth clauses, the method further includes:
determining, based on a third syntax element, whether a neural network-based in-loop filter technology is enabled for a current picture block in which the current coding tree unit is located; and
determining, based on the first syntax element, the target in-loop filter model of the current coding tree unit from the candidate in-loop filter models based on the neural network, in a case where it is determined, based on the third syntax element, that the neural network-based in-loop filter technology is enabled for the current picture block in which the current coding tree unit is located.

In a seventh clause, according to the method of sixth clause, the third syntax element includes at least one of:
a third syntax element at a picture sequence level, used for indicating whether the neural network-based in-loop filter technology is enabled for a picture sequence;
a third syntax element at a picture level, used for indicating whether the neural network-based in-loop filter technology is enabled for a picture;
a third syntax element at a slice level, used for indicating whether the neural network-based in-loop filter technology is enabled for a slice; or
a third syntax element at a coding tree unit level, used for indicating whether the neural network-based in-loop filter technology is enabled for a coding tree unit.

In an eighth clause, according to the method of any one of the second to seventh clauses, the method further includes:
determining, based on a fourth syntax element, a picture type of the current coding tree unit or a slice type of the current coding tree unit; and
determining, based on the first syntax element, the target in-loop filter model of the current coding tree unit from the candidate in-loop filter models based on the neural network, in a case where it is determined, based on the fourth syntax element, that the picture type of the current coding tree unit or the slice type of the current coding tree unit is a preset type.

In a ninth clause, according to the method of any one of the second to eighth clauses, the method further includes:
determining, based on a fifth syntax element, whether a neural network-based in-loop filter technology is allowed to be enabled for a current picture block.

In a tenth clause, according to the method of any one of the first to ninth clauses, the reference sample information further includes: a quantization parameter; and the method further includes:
determining, based on a sixth syntax element, whether to adjust a quantization parameter of a current picture block in which the current coding tree unit is located;
determining, based on a seventh syntax element, an adjusted quantization parameter of the current picture block in which the current coding tree unit is located, in a case where it is determined, based on the sixth syntax element, to adjust the quantization parameter of the current picture block in which the current coding tree unit is located; and
inputting the adjusted quantization parameter into the target in-loop filter model.

In an eleventh clause, according to the method of the tenth clause, the sixth syntax element includes at least one of:
a sixth syntax element at a picture sequence level, used for indicating whether to adjust a quantization parameter of a coding tree unit in a picture sequence;
a sixth syntax element at a picture level, used for indicating whether to adjust a quantization parameter of a coding tree unit in a picture;
a sixth syntax element at a slice level, used for indicating whether to adjust a quantization parameter of a coding tree unit in a slice; or
a sixth syntax element at a coding tree unit level, used for indicating whether to adjust a quantization parameter of a coding tree unit; and
the seventh syntax element includes one of:
a seventh syntax element at a picture sequence level, used for indicating adjusted quantization parameters of all coding tree units in the picture sequence;
a seventh syntax element at a picture level, used for indicating adjusted quantization parameters of all coding tree units in the picture;
a seventh syntax element at a slice level, used for indicating adjusted quantization parameters of all coding tree units in the slice; and
a seventh syntax element at a coding tree unit level, used for indicating an adjusted quantization parameter of the coding tree unit.

In a twelfth clause, according to the method of any one of the fourth to eleventh clauses, the current picture block includes at least one of: a picture sequence in which the current coding tree unit is located, a picture in which the current coding tree unit is located, a slice in which the current coding tree unit is located, or a current picture tree unit.

In a thirteenth clause, according to the method of the first clause, the reference sample information further includes at least one of: a quantization parameter, boundary strength information of the current coding tree unit, reconstructed sample information of a coding tree unit corresponding to the current coding tree unit in a reference picture, a slice type of the current coding tree unit, or partition information of the current coding tree unit.

In a fourteenth clause, according to the method of the thirteenth clause, the candidate in-loop filter models includes a first in-loop filter model and a second in-loop filter model, where
reference sample information input into the first in-loop filter model further includes: a quantization parameter and boundary strength information of the current coding tree unit; and
reference sample information input into the second in-loop filter model further includes: a quantization parameter, reconstructed sample information of a coding tree unit corresponding to the current coding tree unit in a forward reference picture, and reconstructed sample information of a coding tree unit corresponding to the current coding tree unit in a backward reference picture.

In a fifteenth clause, according to the method of the fourteenth clause, the method further includes:
in a case where the target in-loop filter model is the second in-loop filter model, obtaining a first reference picture of a first reference picture list, and obtaining a first reference picture of a second reference picture list;
in a case where the first reference picture of the first reference picture list and the first reference picture of the second reference picture list are a same picture, obtaining a second reference picture of the first reference picture list or a second reference picture of the second reference picture list; and
using an obtained reference picture of the first reference picture list as the forward reference picture, and using an obtained reference picture of the second reference picture list as the backward reference picture.

In a sixteenth clause, according to the method of any one of the first to fifteenth clauses, the method further includes:
in a case where a temporal layer of the current coding tree unit is greater than or equal to a temporal layer threshold, determining that the target in-loop filter model of the current coding tree unit is a second in-loop filter model; and
in a case where the temporal layer of the current coding tree unit is less than the temporal layer threshold, determining, based on the relevant syntax element, the target in-loop filter model of the current coding tree unit from the candidate in-loop filter models based on neural network.

In a seventeenth clause, according to the method of any one of the first to sixteenth clauses, the current coding tree unit is a largest coding unit, or the current coding tree unit is obtained by performing a scale change on the largest coding unit.

In an eighteenth clause, provided is an encoding method, and the method includes:
determining reference sample information of a current coding tree unit, where the reference sample information at least includes: predicted sample information of the current coding tree unit and/or reconstructed sample information of the current coding tree unit;
inputting the reference sample information of the current coding tree unit into each of candidate in-loop filter models based on neural network for filtering, to output respective filtered reconstructed sample information;
determining, based on original sample information of the current coding tree unit and the respective filtered reconstructed sample information, a respective first distortion cost value of the current coding tree unit;
determining, based on first distortion cost values of the current coding tree unit, a target in-loop filter model of the current coding tree unit from the candidate in-loop filter models based on neural network; and
encoding a relevant syntax element of the target in-loop filter model of the current coding tree unit, and signaling obtained encoded bits into a bitstream.

In a nineteenth clause, according to the method of the eighteenth clause, the method further includes:
setting a first syntax element based on the target in-loop filter model of the current coding tree unit.

In a twentieth clause, according to the method of the nineteenth clause, the first syntax element includes one of:
a first syntax element at a picture sequence level, used for indicating target in-loop filter models of all coding tree units in a picture sequence;
a first syntax element at a picture level, used for indicating target in-loop filter models of all coding tree units in a picture;
a first syntax element at a slice level, used for indicating target in-loop filter models of all coding tree units in a slice; and
a first syntax element at a coding tree unit level, used for indicating a target in-loop filter model of a coding tree unit.

In a twenty-first clause, according to the method of the nineteenth clause, the method further includes:
setting a second syntax element based on whether a second in-loop filter model based on neural network is allowed to be enabled for a current picture block; where the second in-loop filter model is a candidate in-loop filter model other than a first in-loop filter model; and
setting the first syntax element based on the target in-loop filter model of the current coding tree unit, in a case where it is determined that the second in-loop filter model based on neural network is enabled for the current picture block in which the current coding tree unit is located.

In a twenty-second clause, according to the method of the twenty-first clause, the second syntax element includes at least one of:
a second syntax element at a picture sequence level, used for indicating whether the second in-loop filter model based on neural network is allowed to be enabled for a picture sequence;
a second syntax element at a picture level, used for indicating whether the second in-loop filter model based on neural network is allowed to be enabled for a picture;
a second syntax element at a slice level, used for indicating whether the second in-loop filter model based on neural network is allowed to be enabled for a slice; or
a second syntax element at a coding tree unit level, used for indicating whether the second in-loop filter model based on neural network is allowed to be enabled for a coding tree unit.

In a twenty-third clause, according to the method of any one of the nineteenth to twenty-second clauses, the method further includes:
setting a third syntax element based on whether a neural network-based in-loop filter technology is enabled for a current picture block in which the current coding tree unit is located; and
setting the first syntax element based on the target in-loop filter model of the current coding tree unit, in a case where it is determined that the neural network-based in-loop filter technology is enabled for the current picture block in which the current coding tree unit is located.

In a twenty-fourth clause, according to the method of the twenty-third clause, the third syntax element includes at least one of:
a third syntax element at a picture sequence level, used for indicating whether the neural network-based in-loop filter technology is enabled for a picture sequence;
a third syntax element at a picture level, used for indicating whether the neural network-based in-loop filter technology is enabled for a picture;
a third syntax element at a slice level, used for indicating whether the neural network-based in-loop filter technology is enabled for a slice; or
a third syntax element at a coding tree unit level, used for indicating whether the neural network-based in-loop filter technology is enabled for a coding tree unit.

In a twenty-fifth clause, according to the method of any one of the nineteenth to twenty-fourth clauses, the method further includes:
setting a fourth syntax element based on a picture type of the current coding tree unit or a slice type of the current coding tree unit; and
setting the first syntax element based on the target in-loop filter model of the current coding tree unit, in a case where it is determined that the picture type of the current coding tree unit or the slice type of the current coding tree unit is a preset type.

In a twenty-sixth clause, according to the method any one of the nineteenth to twenty-fifth clauses, the method further includes:
setting a fifth syntax element based on whether a neural network-based in-loop filter technology is allowed to be enabled for a current picture block.

In a twenty-seventh clause, according to the method any one of the eighteenth to twenty-sixth clauses, where determining, based on the first distortion cost values of the current coding tree unit, the target in-loop filter model of the current coding tree unit from the candidate in-loop filter models based on neural network includes:
determining a first distortion cost value of a current picture block by accumulating first distortion cost values of all coding tree units in the current picture block in which the current coding tree unit is located; and
determining, based on first distortion cost values of the current picture block corresponding to the candidate in-loop filter models, the target in-loop filter model of the current coding tree unit.

In a twenty-eighth clause, according to the method of the twenty-seventh clause, the method further includes:
determining, based on the original sample information of the current coding tree unit and the reconstructed sample information of the reference sample information, a second distortion cost value of the current coding tree unit;
determining a second distortion cost value of the current picture block by accumulating second distortion cost values of all coding tree units in the current picture block in which the current coding tree unit is located; and
determining, based on a smallest distortion cost value between the first distortion cost values of the current picture block and the second distortion cost value of the current picture block, whether a neural network-based in-loop filter technology is allowed to be enabled for the current picture block.

In a twenty-ninth clause, according to the method of any one of the eighteenth to twenty-eighth clauses, the reference sample information further includes: candidate quantization parameters; and
the method further includes: determining, based on the first distortion cost values of the current coding tree unit, a target quantization parameter of a current picture block in which the current coding tree unit is located from the candidate quantization parameters.

In a thirtieth clause, according to the method of the twenty-ninth clause, the method further includes:
determining, based on the target quantization parameter of the current picture block in which the current coding tree unit is located, whether to adjust a quantization parameter of the current picture block in which the current coding tree unit is located, to set a sixth syntax element; and
setting a seventh syntax element based on the target quantization parameter of the current picture block in which the current coding tree unit is located, in a case where it is determined to adjust the quantization parameter of the current picture block in which the current coding tree unit is located.

In a thirty-first clause, according to the method of the thirtieth clause, the sixth syntax element includes at least one of:
a sixth syntax element at a picture sequence level, used for indicating whether to adjust a quantization parameter of a coding tree unit in a picture sequence;
a sixth syntax element at a picture level, used for indicating whether to adjust a quantization parameter of a coding tree unit in a picture;
a sixth syntax element at a slice level, used for indicating whether to adjust a quantization parameter of a coding tree unit in a slice; or
a sixth syntax element at a coding tree unit level, used for indicating whether to adjust a quantization parameter of a coding tree unit; or
the seventh syntax element includes one of:
a seventh syntax element at a picture sequence level, used for indicating adjusted quantization parameters of all coding tree units in the picture sequence;
a seventh syntax element at a picture level, used for indicating adjusted quantization parameters of all coding tree units in the picture;
a seventh syntax element at a slice level, used for indicating adjusted quantization parameters of all coding tree units in the slice; and
a seventh syntax element at a coding tree unit level, used for indicating an adjusted quantization parameter of the coding tree unit.

In a thirty-second clause, according to the method of any one of the twenty-first to thirty-first clauses, the current picture block includes at least one of: a picture sequence in which the current coding tree unit is located, a picture in which the current coding tree unit is located, a slice in which the current coding tree unit is located, or a current picture tree unit.

In a thirty-third clause, according to the method of the eighteenth clause, the reference sample information further includes at least one of: a quantization parameter, boundary strength information of the current coding tree unit, reconstructed sample information of a coding tree unit corresponding to the current coding tree unit in a reference picture, a slice type of the current coding tree unit, or partition information of the current coding tree unit.

In a thirty-fourth clause, according to the method of the thirty-third clause, the candidate in-loop filter models include a first in-loop filter model and a second in-loop filter model; where
reference sample information input into the first in-loop filter model further includes: a quantization parameter and boundary strength information of the current coding tree unit; and
reference sample information input into the second in-loop filter model further includes: a quantization parameter, reconstructed sample information of a coding tree unit corresponding to the current coding tree unit in a forward reference picture, and reconstructed sample information of a coding tree unit corresponding to the current coding tree unit in a backward reference picture.

In a thirty-fifth clause, according to the method of the thirty-fourth clause, the method further includes:
in a case where the candidate in-loop filter model is the second in-loop filter model, obtaining a first reference picture of a first reference picture list, and obtaining a first reference picture of a second reference picture list;
in a case where the first reference picture of the first reference picture list and the first reference picture of the second reference picture list are a same picture, obtaining a second reference picture of the first reference picture list or a second reference picture of the second reference picture list;
using an obtained reference picture of the first reference picture list as the forward reference picture, and using an obtained reference picture of the second reference picture list as the backward reference picture.

In a thirty-sixth clause, according to the method of any one of the eighteenth to thirty-fifth clauses, the method further includes:
in a case where a temporal layer of the current coding tree unit is greater than or equal to a temporal layer threshold, determining that the target in-loop filter model of the current coding tree unit is a second in-loop filter model; and
in a case where the temporal layer of the current coding tree unit is less than the temporal layer threshold, determining the target in-loop filter model of the current coding tree unit from the candidate in-loop filter models based on neural network.

In a thirty-seventh clause, according to the method of any one of the eighteenth to thirty-sixth clauses, the current coding tree unit is a largest coding unit, or the current coding tree unit is obtained by performing a scale change on the largest coding unit.

In a thirty-eighth clause, provided is a decoding apparatus, and the apparatus includes:
a decoding unit, configured to decode a bitstream to determine a relevant syntax element of a current coding tree unit;
a first determining unit, configured to determine, based on the relevant syntax element, a target in-loop filter model of the current coding tree unit from candidate in-loop filter models based on neural network;
a second determining unit, configured to determine reference sample information of the current coding tree unit; where the reference sample information at least includes: predicted sample information of the current coding tree unit and/or reconstructed sample information of the current coding tree unit; and
a filtering unit, configured to input the reference sample information of the current coding tree unit into the target in-loop filter model for filtering, to output a filtered reconstructed sample information.

In a thirty-ninth clause, provided is an encoding apparatus, and the apparatus includes:
a first determining unit, configured to determine reference sample information of a current coding tree unit, where the reference sample information at least includes: predicted sample information of the current coding tree unit and/or reconstructed sample information of the current coding tree unit;
a filtering unit, configured to input the reference sample information of the current coding tree unit into each of candidate in-loop filter models based on neural network for filtering, to output respective filtered reconstructed sample information;
a second determining unit, configured to determine, based on original sample information of the current coding tree unit and the respective filtered reconstructed sample information, a respective first distortion cost value of the current coding tree unit; and determine, based on first distortion cost values of the current coding tree unit, a target in-loop filter model of the current coding tree unit from the candidate in-loop filter models based on neural network; and
a coding unit, configured to encode a relevant syntax element of the target in-loop filter model of the current coding tree unit, and signal obtained encoded bits into a bitstream.

In a fortieth clause, provided is a decoding device, and the decoding device includes: a first memory and a first processor, where
the first memory stores a computer program executable on the first processor, and when the first processor executes the computer program, the decoding method according to any one of the first to seventeenth clauses.

In a forty-first clause, provided is an encoding device, and the encoding device includes: a second memory and a second processor, where
the second memory stores a computer program executable on the second processor, and when the second processor executes the computer program, the encoding method according to any one of the eighteenth to thirty-seventh clauses.

In a forty-second clause, provided is a computer-readable storage medium, having stored thereon a computer program that, where when the computer program is executed by a first processor, the decoding method according to any one of the first to seventeenth clauses is implemented; or when the computer program is executed by a second processor, the encoding method according to any one of the eighteenth to thirty-seventh clauses is implemented.

It should be pointed out here that the description of the above non-transitory storage medium and apparatus embodiments is similar to the description of the above method embodiments, and has similar beneficial effects as the method embodiments. For technical details not disclosed in the non-transitory storage medium and apparatus embodiments of the present disclosure, please refer to the description of the method embodiments of the present disclosure for understanding. It should be noted that: “first,” “second,” etc. are used to distinguish similar objects, and are not necessarily used to describe a specific order or sequence.

The methods disclosed in several method embodiments provided in the present disclosure may be arbitrarily combined without conflict to obtain new method embodiments. The features disclosed in several product embodiments provided in the present disclosure may be arbitrarily combined without conflict to obtain new product embodiments. The features disclosed in several method or device embodiments provided in the present disclosure may be arbitrarily combined without conflict to obtain new method embodiments or device embodiments. The above contents are only specific implementations of the present disclosure, but the protection scope of the present disclosure is not limited thereto, and changes or substitutions, which may be easily thought by any skilled familiar with this technical field, within the technical scope disclosed in the present application should be all covered within the protection scope of the present application. Therefore, the protection scope of the present application should be subject to the protection scope of the claims.

### INDUSTRIAL APPLICABILITY

The present disclosure provides an encoding method, a decoding method, an encoding apparatus, a decoding apparatus, an encoding device, a decoding device, and a storage medium. The decoding method includes: decoding a bitstream to determine a relevant syntax element of a current coding tree unit; determining, based on the relevant syntax element, a target in-loop filter model of the current coding tree unit from candidate in-loop filter models based on neural network; determining reference sample information of the current coding tree unit; where the reference sample information at least includes: predicted sample information and/or reconstructed sample information of the current coding tree unit; inputting the reference sample information of the current coding tree unit into the target in-loop filter model for filtering, to output filtered reconstructed sample information. An encoding end uses candidate in-loop filter modules to filter coding tree units, calculates distortion cost values, determines a target in-loop filter model corresponding to the smallest distortion cost value, signals a relevant syntax element into a bitstream, and a decoding end only needs to parse the bitstream and select the best target in-loop filter model for the current coding tree unit based on the relevant syntax element, thereby improving the filtering performance of the reconstructed samples of the current coding tree unit.

What is claimed is:

1. A decoding method, comprising:
decoding a bitstream to determine a relevant syntax element of a current coding tree unit;
determining, based on the relevant syntax element, a target in-loop filter model of the current coding tree unit from candidate in-loop filter models based on neural network;
determining reference sample information of the current coding tree unit; wherein the reference sample information at least comprises: predicted sample information of the current coding tree unit and/or reconstructed sample information of the current coding tree unit; and
inputting the reference sample information of the current coding tree unit into the target in-loop filter model for filtering, to output filtered reconstructed sample information.

2. The method according to claim 1, comprising:
determining, based on a first syntax element, the target in-loop filter model of the current coding tree unit from the candidate in-loop filter models based on neural network.

3. The method according to claim 2, wherein
the first syntax element comprises one of:
a first syntax element at a picture sequence level, used for indicating target in-loop filter models of all coding tree units in a picture sequence;
a first syntax element at a picture level, used for indicating target in-loop filter models of all coding tree units in a picture;
a first syntax element at a slice level, used for indicating target in-loop filter models of all coding tree units in a slice; and
a first syntax element at a coding tree unit level, used for indicating a target in-loop filter model of a coding tree unit.

4. The method according to claim 2, further comprising:
determining, based on a second syntax element, whether a second in-loop filter model based on neural network is allowed to be enabled for a current picture block in which the current coding tree unit is located; wherein the second in-loop filter model is a candidate in-loop filter model; and
determining, based on the first syntax element, the target in-loop filter model of the current coding tree unit from the candidate in-loop filter models based on neural network, in a case where it is determined, based on the second syntax element, that the second loop filtering model based on the neural network is enabled for the current picture block in which the current coding tree unit is located.

5. The method according to claim 4, wherein
the second syntax element comprises at least one of:
a second syntax element at a picture sequence level, used for indicating whether the second in-loop filter model based on neural network is allowed to be enabled for a picture sequence;
a second syntax element at a picture level, used for indicating whether the second in-loop filter model based on neural network is allowed to be enabled for a picture;
a second syntax element at a slice level, used for indicating whether the second in-loop filter model based on neural network is allowed to be enabled for a slice; or
a second syntax element at a coding tree unit level, used for indicating whether the second in-loop filter model based on neural network is allowed to be enabled for a coding tree unit.

6. The method according to claim 2, further comprising:
determining, based on a fourth syntax element, a picture type of the current coding tree unit or a slice type of the current coding tree unit; and
determining, based on the first syntax element, the target in-loop filter model of the current coding tree unit from the candidate in-loop filter models based on the neural network, in a case where it is determined, based on the fourth syntax element, that the picture type of the current coding tree unit or the slice type of the current coding tree unit is a preset type.

7. The method according to claim 1, wherein the reference sample information further comprises at least one of: a quantization parameter, boundary strength information of the current coding tree unit, reconstructed sample information of a coding tree unit corresponding to the current coding tree unit in a reference picture, a slice type of the current coding tree unit, or partition information of the current coding tree unit.

8. The method according to claim 7, wherein the candidate in-loop filter models comprise a first in-loop filter model and a second in-loop filter model, wherein
reference sample information input into the first in-loop filter model further comprises: a quantization parameter and boundary strength information of the current coding tree unit; and
reference sample information input into the second in-loop filter model further comprises: a quantization parameter, reconstructed sample information of a coding tree unit corresponding to the current coding tree unit in a forward reference picture, and reconstructed sample information of a coding tree unit corresponding to the current coding tree unit in a backward reference picture.

9. The method according to claim 8, further comprising:
in a case where the target in-loop filter model is the second in-loop filter model, obtaining a first reference picture of a first reference picture list, and obtaining a first reference picture of a second reference picture list;
in a case where the first reference picture of the first reference picture list and the first reference picture of the second reference picture list are a same picture, obtaining a second reference picture of the first reference picture list or a second reference picture of the second reference picture list; and
using an obtained reference picture of the first reference picture list as the forward reference picture, and using an obtained reference picture of the second reference picture list as the backward reference picture.

10. The method according to claim 1, further comprising:
in a case where a temporal layer of the current coding tree unit is greater than or equal to a temporal layer threshold, determining that the target in-loop filter model of the current coding tree unit is a second in-loop filter model; and
in a case where the temporal layer of the current coding tree unit is less than the temporal layer threshold, determining, based on the relevant syntax element, the target in-loop filter model of the current coding tree unit from the candidate in-loop filter models based on neural network.

11. An encoding method, comprising:
determining reference sample information of a current coding tree unit, wherein the reference sample information at least comprises: predicted sample information of the current coding tree unit and/or reconstructed sample information of the current coding tree unit;
inputting the reference sample information of the current coding tree unit into each of candidate in-loop filter models based on neural network for filtering, to output respective filtered reconstructed sample information;
determining, based on original sample information of the current coding tree unit and the respective filtered reconstructed sample information, a respective first distortion cost value of the current coding tree unit;
determining, based on first distortion cost values of the current coding tree unit, a target in-loop filter model of the current coding tree unit from the candidate in-loop filter models based on neural network; and
encoding a relevant syntax element of the target in-loop filter model of the current coding tree unit, and signaling obtained encoded bits into a bitstream.

12. The method according to claim 11, further comprising:
setting a first syntax element based on the target in-loop filter model of the current coding tree unit.

13. The method according to claim 12, wherein
the first syntax element comprises one of:
a first syntax element at a picture sequence level, used for indicating target in-loop filter models of all coding tree units in a picture sequence;
a first syntax element at a picture level, used for indicating target in-loop filter models of all coding tree units in a picture;
a first syntax element at a slice level, used for indicating target in-loop filter models of all coding tree units in a slice; and
a first syntax element at a coding tree unit level, used for indicating a target in-loop filter model of a coding tree unit.

14. The method according to claim 12, further comprising:
setting a second syntax element based on whether a second in-loop filter model based on neural network is allowed to be enabled for a current picture block; wherein the second in-loop filter model is a candidate in-loop filter model other than a first in-loop filter model; and
setting the first syntax element based on the target in-loop filter model of the current coding tree unit, in a case where it is determined that the second in-loop filter model based on neural network is enabled for the current picture block in which the current coding tree unit is located.

15. The method according to claim 14, wherein
the second syntax element comprises at least one of:
a second syntax element at a picture sequence level, used for indicating whether the second in-loop filter model based on neural network is allowed to be enabled for a picture sequence;
a second syntax element at a picture level, used for indicating whether the second in-loop filter model based on neural network is allowed to be enabled for a picture;
a second syntax element at a slice level, used for indicating whether the second in-loop filter model based on neural network is allowed to be enabled for a slice; or
a second syntax element at a coding tree unit level, used for indicating whether the second in-loop filter model based on neural network is allowed to be enabled for a coding tree unit.

16. The method according to claim 12, further comprising:
setting a fourth syntax element based on a picture type of the current coding tree unit or a slice type of the current coding tree unit; and
setting the first syntax element based on the target in-loop filter model of the current coding tree unit, in a case where it is determined that the picture type of the current coding tree unit or the slice type of the current coding tree unit is a preset type.

17. The method according to claim 11, wherein the reference sample information further comprises at least one of: a quantization parameter, boundary strength information of the current coding tree unit, reconstructed sample information of a coding tree unit corresponding to the current coding tree unit in a reference picture, a slice type of the current coding tree unit, or partition information of the current coding tree unit.

18. The method according to claim 17, wherein the candidate in-loop filter models comprise a first in-loop filter model and a second in-loop filter model; wherein
reference sample information input into the first in-loop filter model further comprises: a quantization parameter and boundary strength information of the current coding tree unit; and
reference sample information input into the second in-loop filter model further comprises: a quantization parameter, reconstructed sample information of a coding tree unit corresponding to the current coding tree unit in a forward reference picture, and reconstructed sample information of a coding tree unit corresponding to the current coding tree unit in a backward reference picture.

19. The method according to claim 18, further comprising:
in a case where the candidate in-loop filter model is the second in-loop filter model, obtaining a first reference picture of a first reference picture list, and obtaining a first reference picture of a second reference picture list;
in a case where the first reference picture of the first reference picture list and the first reference picture of the second reference picture list are a same picture, obtaining a second reference picture of the first reference picture list or a second reference picture of the second reference picture list;
using an obtained reference picture of the first reference picture list as the forward reference picture, and using an obtained reference picture of the second reference picture list as the backward reference picture.

20. A non-transitory computer-readable storage medium, having stored thereon a bitstream, wherein the bitstream is generated according to the encoding method according to claim 11.
